(19) United States
(12) Patent Application Publication
(10) Pub. No.: US 2025/0023684 A1
(43) Pub. Date: Jan. 16, 2025

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/898,729

(22) Filed: Sep. 27, 2024

Related U.S. Application Data
(63) Continuation of application No. PCT/CN2023/085850, filed on Apr. 3, 2023.

(30) Foreign Application Priority Data
Apr. 6, 2022 (CN) 202210368461.9
Apr. 21, 2022 (CN) 202210423078.9

(51) Int. Cl. H04L 5/00

(52) U.S. Cl. CPC H04L 5/0048

(57) ABSTRACT

A first node receives a first signaling and a second signaling; transmits a first signal in a first symbol group; and transmits or drops transmitting a second signal in a third symbol group. The first signaling is used to determine the first symbol group, the second signaling is used to determine a second symbol group, and the second symbol group is assigned to the second signal; the third symbol group comprises at least a part of the second symbol group overlapping with the first symbol group; the first signal is associated with a first reference signal resource; the second signal is associated with a second reference signal resource; whether the first node transmits the second signal in the third symbol group is related to whether the first reference signal resource and the second reference signal resource belong to a same reference signal resource group.

### CROSS REFERENCE TO RELATED APPLICATIONS

This application is the continuation of the international patent application No. PCT/CN2023/085850, filed on Apr. 3, 2023, and claims the priority benefit of Chinese Patent Application 202210368461.9, filed on Apr. 6, 2022, and claims the priority benefit of Chinese Patent Application 202210423078.9, filed on Apr. 21, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Background

Multi-antenna technology is a key technique in both 3rd Generation Partner Project (3GPP) Long-term Evolution (LTE) and New Radio (NR) systems. By configuring multiple antennas at a communication node, for instance, at a base station or a User Equipment (UE) to acquire extra spatial degrees of freedom. The multiple antennas form through beamforming a beam pointing in a specific direction to improve communication quality. When the multiple antennas belong to multiple Transmitter Receiver Points (TRPs)/panels, the spatial differences among these TRPs/panels can be utilized to get extra diversity gains. In NR R (release) 16, transmission based on multiple beams/TRPs/panels is introduced to enhance the transmission quality of downlink data. In NR R17, uplink transmission based on multiple beams/TRPs/panels is supported to improve the reliability of uplink transmission. In R17, a UE can be configured with multiple codebook-based or non-codebook-based Sounding Reference Signal (SRS) resource sets, and different SRS resource sets correspond to different beams/TRP/panels, which are used to achieve uplink transmission of multiple beams/TRPs/panels.

In 3GPP, when overlapping of different uplink channels/signals occurs in time domain, it is a common means to drop the transmission of partial uplink channels/signals to resolve the overlapping, to satisfy the power constraints of the uplink transmission and/or to reduce the PAPR.

### SUMMARY

Uplink transmission based on multiple SRS resource sets can adopt time-division multiplexing (that is, occupying mutually orthogonal time-domain resources), such as the practice in R17, or can adopt space-division multiplexing or frequency-division multiplexing (that is, occupying overlapping time-domain resources). Compared to time-division multiplexing, space-division or frequency-division multiplexing implementations are more conducive to improving throughput, especially for users with better channel quality. The applicant has found through its researches that uplink channels/signals targeting certain beams/TRPs/panels can be transmitted simultaneously in a space-division or frequency-division multiplexing mode, which can have an impact on the resolution of the overlapping between uplink channels/signals.

To address the above problem, the present application provides a solution. It should be noted that while the above description uses cellular network, uplink transmission and multi-beam/TRP/panel transmission as examples, the present application is also applicable to other scenarios such as sidelink transmission, downlink transmission, and single-beam/TRP/panel transmission, where similar technical effects can be achieved. In addition, the adoption of a unified solution for different scenarios (including, but not limited to, cellular networks, sidelink, uplink transmissions, downlink transmissions, multi-beam/TRP/panel transmission, and single-beam/TRP/panel transmission) also contributes to the reduction of hardware complexity and cost. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling and a second signaling;
transmitting a first signal in a first symbol group; and
transmitting a second signal in a third symbol group, or dropping transmitting a second signal in a third symbol group;
herein, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first node transmits the second signal or drops transmitting the second signal in the third symbol group is related to whether the first reference signal resource and the second reference signal resource belong to a same reference signal resource group in M reference signal resource groups, M being a positive integer greater than 1.

In one embodiment, a problem to be solved in the present application comprises: how to solve the overlapping between different uplink channels/signals. The above method judges whether to simultaneously transmit different uplink channels/signals or drop transmitting some uplink channels/signals according to reference signal resources associated with different uplink channels/signals, thus solving this problem.

In one embodiment, characteristics of the above method comprise: the first signal and the second signal are overlapping in time domain, and the first node judges whether it can simultaneously transmit the first signal and the second signal according to reference signal resources associated with the first signal and reference signal resources associated with the second signal.

In one embodiment, advantages of the above method comprise: judging whether multiple uplink channels/signals can be transmitted simultaneously according to properties of uplink channels/signals that are overlapping in time domain, improving the efficiency of uplink transmission while ensuring its reliability.

According to one aspect of the present application, it is characterized in that M reference signal resources correspond one-to-one with the M reference signal resource groups, and any of the M reference signal resources is used to determine a spatial relation of each reference signal resource in a corresponding reference signal resource group.

According to one aspect of the present application, it is characterized in that any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal.

According to one aspect of the present application, it is characterized in that the M reference signal resource groups correspond to M UE capability value sets, respectively; at least one UE capability value in any two of the M UE capability value sets is different.

According to one aspect of the present application, it is characterized in that the M reference signal resource groups correspond one-to-one with M cells, and all reference signal resources in any of the M reference signal resource groups are associated with a corresponding cell.

According to one aspect of the present application, it is characterized in that the M reference signal resource groups are respectively configurable.

According to one aspect of the present application, it is characterized in that a priority of the first signal is higher than a priority of the second signal.

According to one aspect of the present application, it is characterized in that the first node comprises a UE.

According to one aspect of the present application, it is characterized in that the first node comprises a relay node.

The present application provides a method in a second node for wireless communications, comprising:
transmitting a first signaling and a second signaling;
receiving a first signal in a first symbol group; and
receiving a second signal in a third symbol group, or dropping receiving a second signal in a third symbol group;
herein, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; a transmitter of the first signal transmits the second signal or drops transmitting the second signal in the third symbol group; whether a transmitter of the first node transmits the second signal or drops transmitting the second signal in the third symbol group is related to whether the first reference signal resource and the second reference signal resource belong to a same reference signal resource group in M reference signal resource groups, M being a positive integer greater than 1.

According to one aspect of the present application, it is characterized in that M reference signal resources correspond one-to-one with the M reference signal resource groups, and any of the M reference signal resources is used to determine a spatial relation of each reference signal resource in a corresponding reference signal resource group.

According to one aspect of the present application, it is characterized in that any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal.

According to one aspect of the present application, it is characterized in that the M reference signal resource groups correspond to M UE capability value sets, respectively; at least one UE capability value in any two of the M UE capability value sets is different.

According to one aspect of the present application, it is characterized in that the M reference signal resource groups correspond one-to-one with M cells, and all reference signal resources in any of the M reference signal resource groups are associated with a corresponding cell.

According to one aspect of the present application, it is characterized in that the M reference signal resource groups are respectively configurable.

According to one aspect of the present application, it is characterized in that a priority of the first signal is higher than a priority of the second signal.

According to one aspect of the present application, it is characterized in that the second node is a base station.

According to one aspect of the present application, it is characterized in that the second node is a UE.

According to one aspect of the present application, it is characterized in that the second node is a relay node.

The present application provides a first node for wireless communication, comprising:
a first receiver, receiving a first signaling and a second signaling;
a first transmitter, transmitting a first signal in a first symbol group; and
the first transmitter, transmitting a second signal in a third symbol group, or dropping transmitting a second signal in a third symbol group;
herein, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first transmitter transmits the second signal or drops transmitting the second signal in the third symbol group is related to whether the first reference signal resource and the second reference signal resource belong to a same reference signal resource group in M reference signal resource groups, M being a positive integer greater than 1.

The present application provides a second node for wireless communications, comprising:
a second transmitter, transmitting a first signaling and a second signaling; and
a second receiver, receiving a first signal in a first symbol group; and
the second receiver, receiving a second signal in a third symbol group, or dropping receiving a second signal in a third symbol group;
herein, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; a transmitter of the first signal transmits the second signal or drops transmitting the second signal in the third symbol group; whether a transmitter of the first node transmits the second signal or drops transmitting the second signal in the third symbol group is related to whether the first reference signal resource and the second reference signal resource belong to a same reference signal resource group in M reference signal resource groups, M being a positive integer greater than 1.

In one embodiment, the present application has the following advantages over conventional schemes:
judging whether multiple uplink channels/signals can be transmitted simultaneously according to properties of uplink channels/signals that are overlapping in time domain, thus improving the efficiency of uplink transmission while ensuring its reliability.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first signaling, a second signaling, a first signal and a second signal according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of transmission according to one embodiment of the present application;

FIG. 6 illustrates a schematic diagram of a first reference signal resource being used to determine a spatial relation of a first signal according to one embodiment of the present application;

FIG. 7 illustrates a schematic diagram of a second reference signal resource being used to determine a spatial relation of a second signal according to one embodiment of the present application;

FIG. 8 illustrates a schematic diagram of whether a first node transmits a second signal or drops transmitting a second signal in a third symbol group being related to whether a first reference signal resource and a second reference signal resource belong to a same reference signal resource group in M reference signal resource groups according to one embodiment of the present application;

FIG. 9 illustrates a schematic diagram of M reference signal resources and M reference signal resource groups according to one embodiment of the present application;

FIG. 10 illustrates a schematic diagram of any of M reference signal resources being used to determine a spatial relation of each reference signal resource in a corresponding reference signal resource group according to one embodiment of the present application;

FIG. 11 illustrates a schematic diagram of M reference signal resource groups and M index values according to one embodiment of the present application;

FIG. 12 illustrates a schematic diagram of M reference signal resource groups and M UE capability value sets according to one embodiment of the present application;

FIG. 13 illustrates a schematic diagram of a first reference signal resource group corresponding to a first UE capability value set according to one embodiment of the present application;

FIG. 14 illustrates a schematic diagram of M reference signal resource groups and M cells according to one embodiment of the present application;

FIG. 15 illustrates a schematic diagram of a reference signal resource being associated with a cell according to one embodiment of the present application;

FIG. 16 illustrates a schematic diagram of M reference signal resource groups respectively being configurable according to one embodiment of the present application;

FIG. 17 illustrates a schematic diagram of M reference signal resource groups and M given reference signal resource groups according to one embodiment of the present application;

FIG. 18 illustrates a schematic diagram of a priority of a first signal being higher than a priority of a second signal according to one embodiment of the present application;

FIG. 19 illustrates a structure block diagram of a processor in a first node according to one embodiment of the present application;

FIG. 20 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

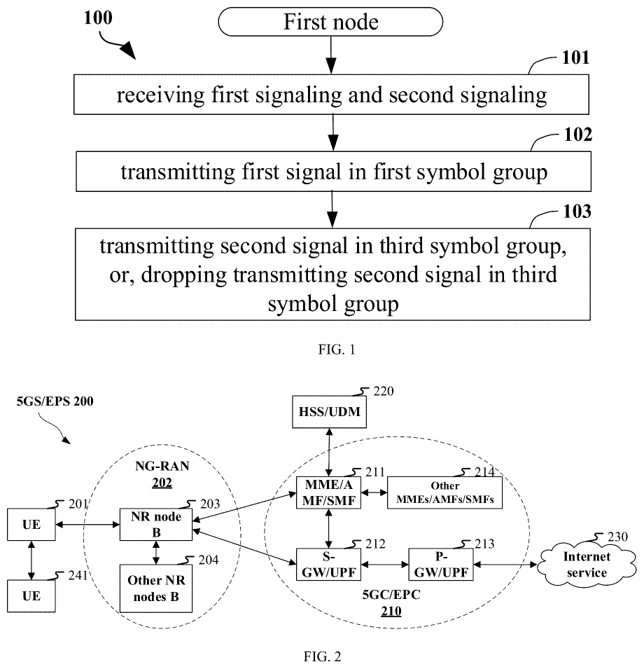

Embodiment 1 illustrates a flowchart of a first signaling, a second signaling, a first signal and a second signal according to one embodiment of the present application, as shown in FIG. 1. In step 100 illustrated by FIG. 1, each box represents a step. and in particular, the order of steps in boxes does not represent chronological order of characteristics between the steps.

In Embodiment 1, the first node in the present application receives a first signaling and a second signaling in step 101; transmits a first signal in a first symbol group in step 102; transmits a second signal in a third symbol group, or drops transmitting a second signal in a third symbol group in step 103; herein, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first node transmits the second signal or drops transmitting the second signal in the third symbol group is related to whether the first reference signal resource and the second reference signal resource belong to a same reference signal resource group in M reference signal resource groups, M being a positive integer greater than 1.

In one embodiment, the first signaling comprises a physical-layer signaling.

In one embodiment, the first signaling comprises a dynamic signaling.

In one embodiment, the first signaling comprises a layer 1 (L1) signaling.

In one embodiment, the first signaling comprises Downlink Control Information (DCI).

In one embodiment, the first signaling is DCI.

In one embodiment, the first signaling comprises a Radio Resource Control (RRC) signaling.

In one embodiment, the first signaling comprises a Medium Access Control layer Control Element (MAC CE).

In one embodiment, the first signaling comprises an Information Element (IE).

In one embodiment, the first signaling comprises information in an IE.

In one embodiment, the first signaling comprises configuration information of the first signal.

In one embodiment, the first signal is transmitted on a PUSCH (Physical Uplink Shared Channel), and the configuration information of the first signal comprises one or more of time-domain resources, frequency-domain resources, MCS (Modulation and Coding Scheme), DMRS (DeModulation Reference Signals) port, HARQ (Hybrid Automatic Repeat request) process number, RV (Redundancy version), NDI (New data indicator), TCI (Transmission Configuration Indicator) state, or SRI (Sounding reference signal resource indicator).

In one embodiment, the first signal is transmitted on a Physical Uplink Control Channel (PUCCH), and the configuration information of the first signal comprises one or more of time-domain resources, frequency-domain resources, PUCCH format, spatial relation, maximum bit rate, maxPayloadSize, cyclic shift, or Orthogonal Cover Code (OCC).

In one embodiment, the first signal comprises an SRS (Sounding Reference Signal), and the configuration information of the first signal comprises one or more of time-domain resources, frequency-domain resources, “usage”, power control parameters, quantity of SRS port(s), number of repetition(s), RS sequence, spatial relation, or cyclic shift.

In one embodiment, the first signal is transmitted on a PUCCH or PUSCH, and the first signal comprises a DMRS.

In one embodiment, the second signaling comprises a physical-layer signaling.

In one embodiment, the second signaling comprises a dynamic signaling.

In one embodiment, the second signaling comprises a layer 1 (L1) signaling.

In one embodiment, the second signaling comprises DCI.

In one embodiment, the second signaling is DCI.

In one embodiment, the second signaling comprises an RRC signaling.

In one embodiment, the second signaling comprises a MAC CE.

In one embodiment, the second signaling comprises an IE.

In one embodiment, the second signaling comprises information in an IE.

In one embodiment, the second signaling comprises configuration information of the second signal.

In one embodiment, the second signal is transmitted on a PUSCH, and the configuration information of the second signal comprises one or more of time-domain resources, frequency-domain resources, MCS, DMRS port, HARQ process number, RV, NDI, TCI status, or SRI.

In one embodiment, the second signal is transmitted on a PUCCH, and the configuration information of the second signal comprises one or more of time-domain resources, frequency-domain resources, PUCCH format, spatial relation, maximum bit rate, maxPayloadSize, cyclic offset, or OCC.

In one embodiment, the second signal comprises an SRS, and the configuration information of the second signal comprises one or more of time-domain resources, frequency-domain resources, “usage”, power control parameters, quantity SRS port(s), number of repetition(s), RS sequence, spatial relation, or cyclic shift.

In one embodiment, the second signal is transmitted on a PUCCH or PUSCH, and the second signal comprises a DMRS.

In one embodiment, the first signaling is earlier than the second signaling in time domain.

In one embodiment, the second signaling is earlier than the first signaling in time domain.

In one embodiment, the first signal comprises a baseband signal.

In one embodiment, the first signal comprises a radio signal.

In one embodiment, the first signal comprises a radio-frequency signal.

In one embodiment, the second signal comprises a baseband signal.

In one embodiment, the second signal comprises a radio signal.

In one embodiment, the second signal comprises a radio-frequency signal.

In one embodiment, the first signal comprises PUSCH transmission, and the second signal comprises an SRS.

In one embodiment, the first signal comprises PUCCH transmission, and the second signal comprises an SRS.

In one embodiment, the first signal comprises an SRS, and the second signal comprises an SRS.

In one embodiment, the first signal comprises an SRS, and the second signal comprises a PUCCH transmission.

In one embodiment, the first signal comprises an SRS, and the second signal comprises a PUSCH transmission.

In one embodiment, the first signal comprises PUCCH transmission, and the second signal comprises a PUSCH transmission.

In one embodiment, the first signal comprises a PUSCH transmission, and the second signal comprises a PUCCH transmission.

In one embodiment, the first signal and the second signal belong to a same cell.

In one embodiment, the first signal and the second signal belong to different cells.

In one embodiment, the first signal and the second signal belong to a same BWP (BandWidth Part).

In one embodiment, the first signal and the second signal belong to a same carrier.

In one embodiment, the first symbol group comprises at least one symbol.

In one embodiment, the first symbol group only comprises one symbol.

In one embodiment, the first symbol group comprises multiple symbols.

In one embodiment, the first symbol group comprises multiple continuous symbols.

In one embodiment, the first symbol group comprises multiple discontinuous symbols.

In one embodiment, the first signaling indicates the first symbol group.

In one embodiment, the first signaling indicates a slot to which the first symbol group belongs.

In one embodiment, the first signaling indicates a number of symbol(s) comprised in the first symbol group.

In one embodiment, the first signaling indicates a first one of symbols in the first symbol group.

In one embodiment, the first signaling indicates a first one of symbols in the first symbol group and a number of symbol(s) comprised in the first symbol group.

In one embodiment, the first signaling indicates a location of a first one of symbols in a slot to which it belongs in the first symbol group and a number of symbol(s) comprised in the first symbol group.

In one embodiment, another signaling different from the first signaling is used to determine a first one of symbols in the first symbol group.

In one subembodiment of the above embodiment, the first signaling and the another signaling are used together to determine the first one of symbols in the first symbol group.

In one subembodiment of the above embodiment, the first signaling is an RRC signaling, and the another signaling is a physical-layer signaling or MAC CE.

In one subembodiment of the above embodiment, the another signaling indicates a slot to which the first one of symbols in the first symbol group belongs; the first signaling indicates a location of the first one of symbols in the first symbol group in a slot to which it belongs.

In one subembodiment of the above embodiment, the another signaling indicates an interval between a slot to which the first one of symbols in the first symbol group belongs and a slot to which the another signaling belongs; the first signaling indicates a location of the first one of symbols in the first symbol group in a slot to which it belongs.

In one embodiment, the first symbol group comprises multiple symbol subgroups, the multiple symbol subgroups occur at equal intervals in time domain, and numbers of symbols comprised in any two symbol subgroups in the multiple symbol subgroups are equal.

In one subembodiment of the above embodiment, any of the multiple symbol subgroups comprises multiple continuous symbols.

In one subembodiment of the above embodiment, the first signaling indicates an interval between any two adjacent symbol subgroups in the multiple symbol subgroups.

In one subembodiment of the above embodiment, the first signaling indicates a number of symbols comprised in each of the multiple symbol subgroups.

In one subembodiment of the above embodiment, the first signaling indicates a first one of symbol subgroups in the multiple symbol subgroups.

In one subembodiment of the above embodiment, another signaling different from the first signal is used to determine a first one of symbol subgroups in the multiple symbol subgroups.

In one reference embodiment of the above subembodiment, the first signaling is an RRC signaling, and the another signaling is a physical-layer signaling or MAC CE.

In one reference embodiment of the above subembodiment, the first signaling and the another signaling are used together to determine the first one of symbol subgroups in the multiple symbol subgroups.

In one reference embodiment of the above subembodiment, the another signaling indicates a slot to which a first one of symbols in the first one of symbol subgroups in the multiple symbol subgroups belongs; the first signaling indicates a location of the first one of symbols in the first one of symbol subgroups of the multiple symbol subgroups in a slot to which it belongs.

In one embodiment, the second symbol group comprises at least one symbol.

In one embodiment, the second symbol group only comprises one symbol.

In one embodiment, the second symbol group comprises multiple symbols.

In one embodiment, the second symbol group comprises multiple continuous symbols.

In one embodiment, the second symbol group comprises multiple discontinuous symbols.

In one embodiment, the second signaling indicates the second symbol group.

In one embodiment, the second signaling indicates a slot to which the second symbol group belongs.

In one embodiment, the second signaling indicates a number of symbol(s) comprised in the second symbol group.

In one embodiment, the second signaling indicates a first one of symbols in the second symbol group.

In one embodiment, the second signaling indicates a first one of symbols in the second symbol group and a number of symbol(s) comprised in the second symbol group.

In one embodiment, the second signaling indicates a location of a first one of symbols in the second symbol group in a slot to which it belongs and a number of symbol(s) comprised in the second symbol group.

In one embodiment, another signaling different from the second signaling is used to determine a first one of symbols in the second symbol group.

In one subembodiment of the above embodiment, the second signaling and the another signaling are used together to determine the first one of symbols in the second symbol group.

In one subembodiment of the above embodiment, the second signaling is an RRC signaling, and the another signaling is a physical-layer signaling or MAC CE.

In one subembodiment of the above embodiment, the another signaling indicates a slot to which the first one of symbols in the second symbol group belongs; the second signaling indicates a location of the first one of symbols in the second symbol group in a slot to which it belongs.

In one subembodiment of the above embodiment, the another signaling indicates an interval between a slot to which the first one of symbols in the second symbol group belongs and a slot to which the another signaling belongs; the second signaling indicates a location of the first one of symbols in the second symbol group in a slot to which it belongs.

In one embodiment, the second symbol group comprises multiple symbol subgroups, the multiple symbol subgroups occur at equal intervals in time domain, and numbers of symbol(s) comprised in any two symbol subgroups in the multiple symbol subgroups are equal.

In one subembodiment of the above embodiment, any of the multiple symbol subgroups comprises multiple continuous symbols.

In one subembodiment of the above embodiment, the second signaling indicates an interval between any two adjacent symbol subgroups in the multiple symbol subgroups.

In one subembodiment of the above embodiment, the second signaling indicates a number of symbol(s) comprised in each of the multiple symbol subgroups.

In one subembodiment of the above embodiment, the second signaling indicates a first one of symbol subgroups in the multiple symbol subgroups.

In one subembodiment of the above embodiment, another signaling different from the second signaling is used to determine a first one of symbol subgroups in the multiple symbol subgroups.

In one reference embodiment of the above subembodiment, the second signaling is an RRC signaling, and the another signaling is a physical-layer signaling or MAC CE.

In one reference embodiment of the above subembodiment, the second signaling and the another signaling are used together to determine the first one of symbol subgroups among the multiple symbol subgroups.

In one reference embodiment of the above subembodiment, the another signaling indicates a slot to which a first one of symbols in the first one of symbol subgroups in the multiple symbol subgroups belongs; the second signaling indicates a location of the first one of symbols in the first one of symbol subgroups of the multiple symbol subgroups in a slot to which it belongs.

In one embodiment, any symbol in the first symbol group belongs to the second symbol group.

In one embodiment, there exists a symbol in the first symbol group not belonging to the second symbol group.

In one embodiment, any symbol in the second symbol group belongs to the first symbol group.

In one embodiment, there exists a symbol in the second symbol group not belonging to the first symbol group.

In one embodiment, the second signaling indicates: the second symbol group is allocated to the second signal.

In one embodiment, the third symbol group comprises at least one symbol.

In one embodiment, the third symbol group comprises only one symbol.

In one embodiment, the third symbol group comprises multiple symbols.

In one embodiment, the third symbol group consists of an overlapping part of the first symbol group and the second symbol group.

In one embodiment, the third symbol group is the second symbol group.

In one embodiment, there exists a symbol in the second symbol group not belonging to the third symbol group.

In one embodiment, each symbol in the second symbol group belongs to the third symbol group.

In one embodiment, the first symbol group and the second symbol group have at least one common symbol.

In one embodiment, the overlapping part of the first symbol group and the second symbol group consists of common symbols from the first symbol group and the second symbol group.

In one embodiment, the third symbol group comprises common symbols in the first symbol group and the second symbol group.

In one embodiment, the third symbol group consists of common symbols in the first symbol group and the second symbol group.

In one embodiment, the third symbol group comprises all symbols belonging to the first symbol group in the second symbol group.

In one embodiment, the third symbol group consists of all symbols belonging to the first symbol group in the second symbol group.

In one embodiment, any symbol in the third symbol group belongs to both the first symbol group and the second symbol group.

In one embodiment, there exists a symbol in the third symbol group only belonging to the second symbol group in the first symbol group and the second symbol group.

In one embodiment, the second signal comprises PUSCH transmission, and the third symbol group is the second symbol group.

In one embodiment, the second signal comprises PUCCH transmission, and the third symbol group is the second symbol group.

In one embodiment, the second signal comprises an SRS, and the third symbol group consists of all symbols belonging to the first symbol group in the second symbol group.

In one embodiment, the symbol comprises an Orthogonal Frequency Division Multiplexing (OFDM) symbol.

In one embodiment, the symbol comprises a Discrete Fourier Transform Spread OFDM (DFT-S-OFDM) symbol.

In one embodiment, the symbol is obtained after an output of the transform precoding is through OFDM symbol generation.

In one embodiment, a reference signal resource comprises a reference signal.

In one embodiment, a reference signal resource comprises a reference signal port.

In one embodiment, a reference signal resource comprises an antenna port.

In one embodiment, the first reference signal resource comprises an uplink reference signal resource.

In one embodiment, the first reference signal resource comprises a downlink reference signal resource.

In one embodiment, the first reference signal resource comprises a Channel State Information Reference Signal(CSI-RS) resource.

In one embodiment, the first reference signal resource comprises an SS/PBCH block (Synchronization Signal/Physical Broadcast Channel Block) resource.

In one embodiment, the first reference signal resource comprises an SRS resource.

In one embodiment, the first reference signal resource is a CSI-RS resource.

In one embodiment, the first reference signal resource is an SS/PBCH Block resource.

In one embodiment, the first reference signal resource is an SRS resource.

In one embodiment, the second reference signal resource comprises an uplink reference signal resource.

In one embodiment, the second reference signal resource comprises a downlink reference signal resource.

In one embodiment, the second reference signal resource comprises a CSI-RS resource.

In one embodiment, the second reference signal resource comprises an SS/PBCH Block resource.

In one embodiment, the second reference signal resource comprises an SRS resource.

In one embodiment, the second reference signal resource is a CSI-RS resource.

In one embodiment, the second reference signal resource is an SS/PBCH Block resource.

In one embodiment, the second reference signal resource is an SRS resource.

In one embodiment, the first reference signal resource and the second reference signal resource are respectively identified by a reference signal resource identifier, and a reference signal resource identifier of the first reference signal resource is different from a reference signal resource identifier of the second reference signal resource.

In one embodiment, a reference signal resource identifier of the first reference signal resource comprises one of NZP-CSI-RS-ResourceId, SSB-Index, or SRS-ResourceId; a reference signal resource identifier of the second reference signal resource comprises one of NZP-CSI-RS-ResourceId, SSB-Index, or SRS-ResourceId.

In one embodiment, a reference signal resource identifier of the first reference signal resource comprises one of CRI (CSI-RS Resource Indicator), SSBRI (SS/PBCH Block Resource Indicator), or SRI (Sounding Reference Signal Resource Indicator); a reference signal resource identifier of the second reference signal resource comprises one of CRI, SSBRI, or SRI.

In one embodiment, the meaning of the phrase that the first signal is associated with a first reference signal resource comprises: the first reference signal resource is used to determine a spatial relation of the first signal.

In one embodiment, the meaning of the phrase that the second signal is associated with a second reference signal resource comprises: the second reference signal resource is used to determine a spatial relation of the second signal.

In one embodiment, the spatial relation comprises a TCI state.

In one embodiment, the spatial relation comprises QCL (Quasi Co-Location) relation.

In one embodiment, the spatial relation comprises a QCL assumption.

In one embodiment, the spatial relation comprises QCL parameters.

In one embodiment, the spatial relation comprises a spatial domain filter.

In one embodiment, the spatial relation comprises a spatial domain transmission filter.

In one embodiment, the spatial relation comprises a spatial domain receive filter.

In one embodiment, the spatial relation comprises a Spatial Tx parameter.

In one embodiment, the spatial relation comprises a Spatial Rx parameter.

In one embodiment, the spatial relation comprises large-scale properties.

In one embodiment, the large-scale properties include one or more of delay spread, Doppler spread, Doppler shift, average delay, or Spatial Rx parameters.

In one embodiment, the spatial relation comprises antenna port.

In one embodiment, the spatial relation comprises pre-coder.

In one embodiment, the meaning of the phrase that the first signal is associated with a first reference signal resource comprises: the first signal comprises a reference signal, and the first signal is transmitted in the first reference signal resource.

In one subembodiment of the above embodiment, the first signal comprises an SRS; the first reference signal resource comprises an SRS resource.

In one subembodiment of the above embodiment, the first reference signal resource is reserved for the first signal.

In one subembodiment of the above embodiment, the first signal is transmitted according to configuration information of the first reference signal resource.

In one embodiment, the meaning of the phrase that the second signal is associated with a second reference signal resource comprises: the second signal comprises a reference signal, and the second reference signal resource is transmitted in the second reference signal resource.

In one embodiment, the meaning of the phrase that the second signal is associated with a second reference signal resource comprises: the second signal comprises an SRS, the second reference signal resource comprises an SRS resource, and the second signal is transmitted in the second reference signal resource.

In one embodiment, the meaning of the phrase that the second signal is associated with a second reference signal resource comprises: the second signal comprises a reference signal, and the second reference signal resources are reserved for the second signal.

In one embodiment, the meaning of the phrase that the second signal is associated with a second reference signal resource comprises: the second signal comprises an SRS, and the second reference signal resource comprise an SRS resource, and the second reference signal resource is reserved for the second signal.

In one embodiment, the meaning of the phrase that the second signal is associated with a second reference signal resource comprises: the second reference signal resource comprises an SRS resource, and the second signal is an SRS corresponding to the second reference signal resource.

In one embodiment, the meaning of the phrase that the second signal is associated with a second reference signal resource comprises: the second signal comprises an SRS, the second reference signal resource comprises an SRS resource, and the second signal is transmitted according to configuration information of the second reference signal resource.

In one embodiment, the first reference signal resource is used to determine a spatial relation of the first signal, and the second reference signal resource is used to determine a spatial relation of the second signal.

In one embodiment, the first reference signal resource is used to determine a spatial relation of the first signal, and the second reference signal resource is reserved for the second signal.

In one embodiment, the first signal is transmitted in the first reference signal resource, and the second reference signal resource is used to determine a spatial relation of the second signal.

In one embodiment, the first signal is transmitted in the first reference signal resource, and the second reference signal resource is reserved for the second signal.

In one embodiment, M is equal to 2.

In one embodiment, M is greater than 2.

In one embodiment, any of the M reference signal resource groups comprises at least one reference signal resource.

In one embodiment, there exists one reference signal resource group in the M reference signal resource groups only comprising one reference signal resource.

In one embodiment, there exists one reference signal resource group in the M reference signal resource groups comprising multiple reference signal resources.

In one embodiment, there exist numbers of reference signal resources comprised in two of the M reference signal resource groups being not equal.

In one embodiment, there exists one reference signal resource group in the M reference signal resource groups comprising downlink reference signal resources.

In one embodiment, there exists one reference signal resource group in the M reference signal resource groups comprising uplink reference signal resources.

In one embodiment, any of the M reference signal resource groups comprises downlink reference signal resources.

In one embodiment, any of the M reference signal resource groups comprises uplink reference signal resources.

In one embodiment, there exists one reference signal resource group in the M reference signal resource groups comprising both downlink reference signal resources and uplink reference signal resources.

In one embodiment, any of the M reference signal resource groups comprises both downlink reference signal resources and uplink reference signal resources.

In one embodiment, there exists one reference signal resource group in the M reference signal resource groups only comprising downlink reference signal resources.

In one embodiment, any of the M reference signal resource groups only comprises downlink reference signal resources.

In one embodiment, there exists one reference signal resource group in the M reference signal resource groups only comprising uplink reference signal resources.

In one embodiment, any of the M reference signal resource groups only comprises uplink reference signal resources.

In one embodiment, there does not exist a reference signal resource both belonging to two of the M reference signal resource groups.

In one embodiment, any reference signal resource in the M reference signal resource groups comprises one of CSI-RS resources, SS/PBCH block resources, or SRS resources.

In one embodiment, any reference signal resource in the M reference signal resource groups is one of CSI-RS resources, SS/PBCH block resources, or SRS resources.

In one embodiment, any reference signal resource in the M reference signal resource groups comprises one of CSI-RS resources, or SS/PBCH block resources.

In one embodiment, any reference signal resource in the M reference signal resource groups is one of CSI-RS resources, or SS/PBCH block resources.

In one embodiment, any reference signal resource in the M reference signal resource groups comprises SRS resources.

In one embodiment, any reference signal resource in the M reference signal resource groups is SRS resources.

In one embodiment, a first reference signal resource group and a second reference signal resource group are any two of the M reference signal resource groups; any reference signal resource in the first reference signal resource group and any reference signal resource in the second reference signal resource group are not QCLed.

In one subembodiment of the above embodiment, any reference signal resource in the first reference signal resource group and any reference signal resource in the second reference signal resource group are not QCLed corresponding to QCL type TypeD.

In one embodiment, a first reference signal resource group and a second reference signal resource group are any two of the M reference signal resource groups; any reference signal resource in the first reference signal resource group and any reference signal resource in the second reference signal resource group cannot be assumed to be QCLed.

In one subembodiment of the above embodiment, any reference signal resource in the first reference signal resource group and any reference signal resource in the second reference signal resource group cannot be assumed to QCLed corresponding to QCL type TypeD.

In one embodiment, any reference signal resource in the M reference signal resource groups is identified by a reference signal resource identifier, and reference signal resource identifiers of any two reference signal resources in the M reference signal resource groups are different.

In one embodiment, a reference signal resource identifier of any reference signal resource in the M reference signal resource groups comprises one of NZP-CSI-RS-ResourceId, SSB-Index, or SRS-ResourceId.

In one embodiment, a reference signal resource identifier of any reference signal resource in the M reference signal resource groups comprises one of CRI, SSBRI, or SRI.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201—oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE201.

In one embodiment, the second node in the present application comprises the gNB203.

In one embodiment, a radio link between the UE201 and the gNB203 comprises a cellular network link.

In one embodiment, transmitters of the first signaling and the second signaling comprise the gNB203.

In one embodiment, receivers of the first signaling and the second signaling comprise the UE201.

In one embodiment, a transmitter of the first signal comprises the UE201.

In one embodiment, a receiver of the first signal comprises the gNB203.

In one embodiment, a transmitter of the second signal comprises the UE201.

In one embodiment, a receiver of the second signal comprises the gNB203.

In one embodiment, the UE201 supports simultaneous multi-beam/panel/TRP UL transmission.

### Embodiment 3

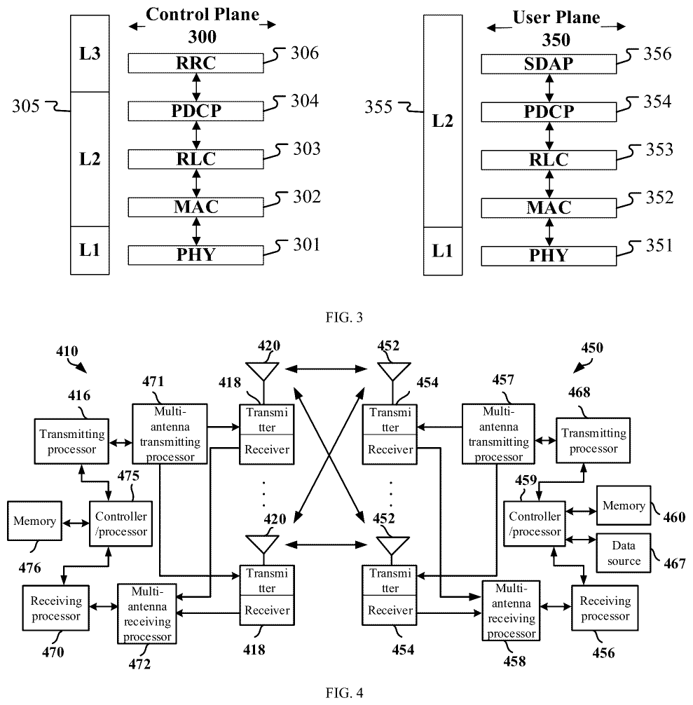

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling is generated by the PHY 301 or the PHY 351.

In one embodiment, the first signaling is generated by the MAC sublayer 302 or the MAC sublayer 352.

In one embodiment, the first information is generated by the RRC sublayer 306.

In one embodiment, the second signaling is generated by the PHY 301 or the PHY 351.

In one embodiment, the second signaling is generated by the MAC sublayer 302 or the MAC sublayer 352.

In one embodiment, the second information is generated by the RRC sublayer 306.

In one embodiment, the first signal is generated at the PHY 301 or the PHY 351.

In one embodiment, the second signal is generated by the PHY 301 or the PHY 351.

In one embodiment, the higher layer in the present application refers to a layer above the physical layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450—targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives the first signaling and the second signaling; transmits the first signal in the first symbol group; transmits the second signal in the third symbol group, or drops transmitting the second signal in the third symbol group.

In one embodiment, the second communication device 450 comprises a memory that stores a computer readable instruction program. The computer readable instruction program generates an action when executed by at least one processor. The action includes: receiving the first signaling and the second signaling; transmitting the first signal in the first symbol group; transmitting the second signal in the third symbol group, or dropping transmitting the second signal in the third symbol group.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first signaling and the second signaling; receives the first signal in the first symbol group; receives the second signal in the third symbol group, or drops receiving the second signal in the third symbol group.

In one embodiment, the first communication device 410 comprises a memory that stores a computer readable instruction program. The computer readable instruction program generates an action when executed by at least one processor. The action includes: transmitting the first signaling and the second signaling; receiving the first signal in the first symbol group; receiving the second signal in the third symbol group, or dropping receiving the second signal in the third symbol group.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first signaling and the second signaling; at least one of the antenna 420, the transmitter 418, the transmitting processor 416, the multi-antenna transmitting processor 471, the controller/processor 475, or the memory 476 is used to transmit the first signaling and the second signaling.

In one embodiment, at least one of the antenna 420, the receiver 418, the receiving processor 470, the multi-antenna receiving processor 472, the controller/processor 475, or the memory 476 is used to receive the first signal in the first symbol group in the present application; at least one of the antenna 452, the transmitter 454, the transmitting processor 468, the multi-antenna transmitting processor 457, the controller/processor 459, the memory 460, or the data source 467 is used to transmit the first signal in the first symbol group in the present application.

In one embodiment, at least one of the antenna 420, the receiver 418, the receiving processor 470, the multi-antenna receiving processor 472, the controller/processor 475, or the memory 476 is used to receive the second signal in the third symbol group in the present application; at least one of the antenna 452, the transmitter 454, the transmitting processor 468, the multi-antenna transmitting processor 457, the controller/processor 459, the memory 460, or the data source 467 is used to transmit the second signal in the third symbol group in the present application.

In one embodiment, at least one of the antenna 420, the receiver 418, the receiving processor 470, the multi-antenna receiving processor 472, the controller/processor 475, or the memory 476 is used to drop receiving the second signal in the third symbol group in the present application; at least one of the antenna 452, the transmitter 454, the transmitting processor 468, the multi-antenna transmitting processor 457, the controller/processor 459, the memory 460, or the data source 467 is used to drop transmitting the second signal in the third symbol group in the present application.

### Embodiment 5

Embodiment 5 illustrates a flowchart of transmission according to one embodiment of the present application, as shown in FIG. 5. In FIG. 5, a second node U1 and a first node U2 are communication nodes transmitted via an air interface. In FIG. 5, steps in blocks F51 to block F54 are respectively optional.

The second node U1 transmits a first signaling in step S511; transmits a second signaling in step S512; and receives a first signal in a first symbol group in step S513; judges whether to receive a second signal in a third symbol group in step S5101; receives a second signal in a third symbol group in step S5102; receives a second signal in a fourth symbol group in step S5103.

The first node U2 receives a first signaling in step S521; receives a second signaling in step S522; transmits a first signal in a first symbol group in step S523; judges whether to transmit a second signal in a third symbol group in step S5201; transmits a second signal in a third symbol group in step S5202; transmits a second signal in a fourth symbol group in step S5203.

In embodiment 5, the first signaling is used by the first node U2 to determine the first symbol group, the second signaling is used by the first node U2 to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first node U2 transmits the second signal or drops transmitting the second signal in the third symbol group is related to whether the first reference signal resource and the second reference signal resource belong to a same reference signal resource group in M reference signal resource groups, M being a positive integer greater than 1.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a relay node and a UE.

In one embodiment, an air interface between the second node U1 and the first node U2 comprises a radio interface between a UE and a UE.

In one embodiment, the second node U1 is a serving cell maintenance base station of the first node U2.

In one embodiment, the first signaling is transmitted in a Physical Downlink Control Channel (PDCCH).

In one embodiment, the first signaling is transmitted in a Physical Downlink Shared Channel (PDSCH).

In one embodiment, the second signaling is transmitted in a PDCCH.

In one embodiment, the second signaling is transmitted in a PDSCH.

In one embodiment, the first signal is transmitted in a PUSCH.

In one embodiment, the first signal is transmitted in a PUCCH.

In one embodiment, the first signal comprises an SRS.

In one embodiment, a physical-layer channel corresponding to the second signal comprises PUSCH.

In one embodiment, a physical-layer channel corresponding to the second signal comprises PUCCH.

In one embodiment, the second signal comprises an SRS.

In one embodiment, steps in box F51 in FIG. 5 exist, and the method used for wireless communication in a first node comprises: judging whether to transmit the second signal in the third symbol group.

In one embodiment, the first node U2 judges whether to transmit the second signal in the third symbol group according to whether the first reference signal resource and the second reference signal resource belong to a same reference signal resource group in the M reference signal resource groups.

In one embodiment, steps in the block F51 in FIG. 5 do not exist.

In one embodiment, steps in block F52 in FIG. 5 exist, and the above method in a second node for wireless communications comprises: judging whether the second signal is received in the third symbol group.

In one embodiment, whether the second node U1 receives the second signal or drops receiving the second signal in the third symbol group is related to whether the first reference signal resource and the second reference signal resource belong to a same reference signal resource group in the M reference signal resource groups.

In one embodiment, the second node U1 judges whether to receive the second signal in the third symbol group according to whether the first reference signal resource and the second reference signal resource belong to a same reference signal resource group in the M reference signal resource groups.

In one embodiment, when the first reference signal resource and the second reference signal resource belong to a same reference signal resource group in the M reference signal resource groups, the second node U1 drops receiving the second signal in the third symbol group; when the first reference signal resource and the second reference signal resource respectively belong to different reference signal resource groups in the M reference signal resource groups, the second node U1 receives the second signal in the third symbol group.

In one embodiment, when a transmitter of the first signal transmits the second signal in the third symbol group, the second node U1 receives the second signal in the third symbol group; when a transmitter of the first signal drops transmitting the second signal in the third symbol group, the second node U1 drops receiving the second signal in the third symbol group.

In one embodiment, steps in the box F52 in FIG. 5 do not exist.

In one embodiment, steps in box F53 in FIG. 5 exist, and the method used for wireless communications in a first node comprises: transmitting the second signal in the third symbol group.

In one subembodiment of the above embodiment, the first node U2 judges to transmit the second signal in the third symbol group.

In one embodiment, steps in block F53 in FIG. 5 do not exist, and the above method in a first node for wireless communications comprises: dropping transmitting the second signal in the third symbol group.

In one subembodiment of the above embodiment, the first node U2 judges to drop transmitting the second signal in the third symbol group.

In one embodiment, steps in box F53 in FIG. 5 exist, and the method used for wireless communications in the second node comprises: receiving the second signal in the third symbol group.

In one subembodiment of the above embodiment, the second node U1 judges to receive the second signal in the third symbol group.

In one embodiment, steps in block F53 in FIG. 5 do not exist, and the above method in a second node for wireless communications comprises: dropping receiving the second signal in the third symbol group.

In one subembodiment of the above embodiment, the second node U1 judges to drop receiving the second signal in the third symbol group.

In one embodiment, steps in box F54 in FIG. 5 exist, and the second symbol group comprises the third symbol group and a fourth symbol group, and the method used in the first node for wireless communications comprises: transmitting the second signal in the fourth symbol group.

In one subembodiment of the above embodiment, the fourth symbol group consists of all symbols in the second symbol group that do not belong to the first symbol group.

In one subembodiment of the above embodiment, the fourth symbol group and the third symbol group are orthogonal to each other.

In one subembodiment of the above embodiment, the fourth symbol group is earlier than the third symbol group in time domain.

In one subembodiment of the above embodiment, the fourth symbol group is later than the third symbol group in time domain.

In one subembodiment of the above embodiment, a part of symbols in the fourth symbol group are earlier in time domain than the third symbol group, while another part of symbols in the fourth symbol group are later in time domain than the third symbol group.

In one subembodiment of the above embodiment, the method in a second node for wireless communications comprises: receiving the second signal in the fourth symbol group.

In one embodiment, the second signal is transmitted in a PUSCH.

In one embodiment, the second signal is transmitted in a PUCCH.

In one embodiment, steps in box F54 in FIG. 5 do not exist.

In one subembodiment of the above embodiment, the third symbol group is the second symbol group.

### Embodiment 6

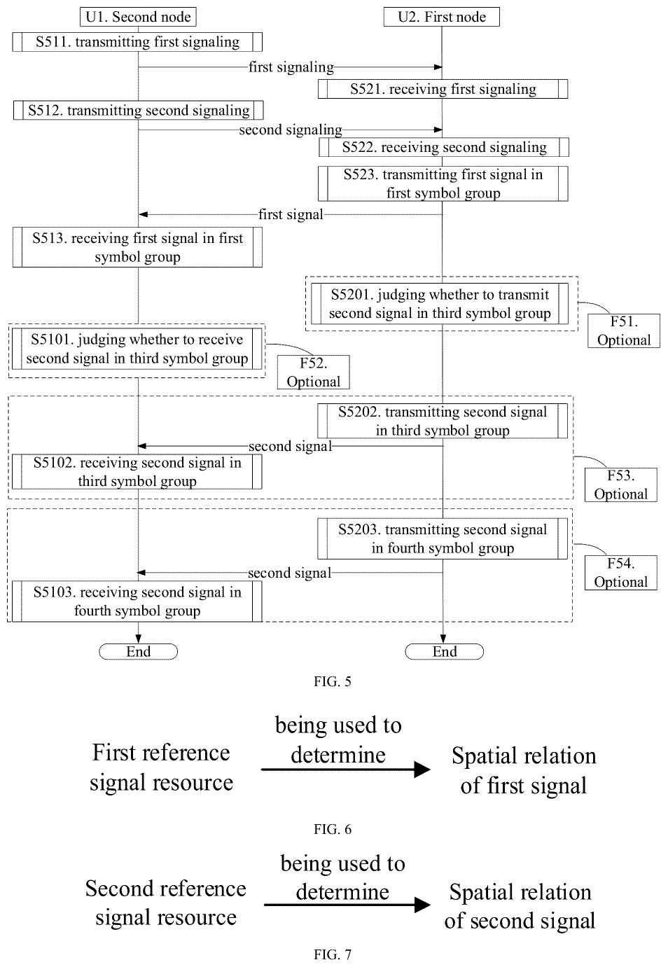

Embodiment 6 illustrates a schematic diagram of a first reference signal resource being used to determine a spatial relation of a first signal according to one embodiment of the present application, as shown in FIG. 6.

In one embodiment, the first reference signal resource is used by the first node to determine the spatial relation of the first signal.

In one embodiment, the first reference signal resource is used directly to determine the spatial relation of the first signal.

In one embodiment, the first node receives a reference signal and transmits the first signal in the first reference signal resource with a same spatial domain filter.

In one embodiment, the first node transmits a reference signal and transmits the first signal in the first reference signal resource with a same spatial domain filter.

In one embodiment, the first reference signal resource comprises an SRS resource, and the first node uses antenna port(s) same as SRS port(s) of the first reference signal resource to transmit the first signal.

In one embodiment, the first reference signal resource is used indirectly to determine the spatial relation of the first signal.

In one embodiment, the first reference signal resource is used to determine a spatial relation of K1 given signal(s), and at least one of the K1 given signal(s) is used to determine the spatial relation of the first signal; K1 being a positive integer.

In one subembodiment of the above embodiment, K1 is equal to 1.

In one subembodiment of the above embodiment, K1 is greater than 1.

In one subembodiment of the above embodiment, the K1 given signal(s) comprises(comprise) an uplink reference signal.

In one subembodiment of the above embodiment, the K1 given signal(s) comprises(comprise) a downlink reference signal.

In one subembodiment of the above embodiment, a first given signal is a downlink reference signal in the K1 given signal(s), and the first given signal and the first reference signal resource are quasi co located (QCLed); the first node uses a same spatial-domain filter to receive the first given signal and transmit the first signal.

In one reference embodiment of the above subembodiment, the first reference signal resource is a downlink reference signal resource.

In one reference embodiment of the above subembodiment, the first given signal comprises a CSI-RS or an SS/PBCH block.

In one reference embodiment of the above subembodiment, a QCL type between the first given signal and the first reference signal resource comprises TypeD.

In one subembodiment of the above embodiment, a first given signal is a downlink reference signal in the K1 given signal(s), and the first node uses a same spatial filter to receive the first given signal and transmit a reference signal in the first reference signal resource; the first node uses a same spatial-domain filter to receive the first given signal and transmit the first signal.

In one reference embodiment of the above subembodiment, the first reference signal resource is a downlink reference signal resource.

In one subembodiment of the above embodiment, a second given signal is an uplink reference signal in the K1 given signal(s), and the first node uses a same spatial filter to transmit the second given signal and transmits or receives a reference signal in the first reference signal resource; the first node uses a same spatial-domain filter to transmit the second reference signal and the first signal.

In one reference embodiment of the above subembodiment, the second given signal comprises an SRS.

In one subembodiment of the above embodiment, a second given signal is an uplink reference signal in the K1 given signal(s), the second given signal comprises an SRS, and the second given signal is transmitted in a second given SRS resource; the first node uses a same spatial filter to transmit the second given signal and transmit or receive a reference signal in the first reference signal resource; the first node uses an antenna port same as an SRS port of the second given SRS resource to transmit the first signal.

In one subembodiment of the above embodiment, a second given signal is an uplink reference signal in the K1 given signal(s), the second given signal comprises an SRS, and the second given signal is transmitted in the second given SRS resource; the first node uses a same spatial filter to transmit the second given signal and transmit or receive a reference signal in the first reference signal resource; the first signal adopts a same precoder as the second given signal.

In one embodiment, the meaning of being QCLed with a reference signal resource comprises: being QCLed with a reference signal transmitted in the reference signal resource.

In one embodiment, the meaning of being QCLed with a reference signal resource comprises: being QCLed with a reference signal port of the reference signal resource.

In one embodiment, the meaning of being QCLed with a reference signal resource comprises: being QCLed with an antenna port of the reference signal resource.

### Embodiment 7

Embodiment 7 illustrates a schematic diagram of a second reference signal resource being used to determine a spatial relation of a second signal according to one embodiment of the present application, as shown in FIG. 7.

In one embodiment, the second reference signal resource is used by the first node to determine the spatial relation of the second signal.

In one embodiment, the second reference signal resource is used directly to determine the spatial relation of the second signal.

In one embodiment, the first node uses a same spatial domain filter to receive a reference signal and transmit the second signal in the second reference signal resource.

In one embodiment, the first node uses a same spatial domain filter to transmit a reference signal and transmit the second signal in the second reference signal resource.

In one embodiment, the second reference signal resource comprises an SRS resource, and the first node uses antenna port(s) same as SRS port(s) of the second reference signal resource to transmit the second signal.

In one embodiment, the second reference signal resource is used indirectly to determine the spatial relation of the second signal.

In one embodiment, the second reference signal resource is used to determine a spatial relation of K2 given signal(s), and at least one of the K2 given signal(s) is used to determine the spatial relation of the second signal; K2 is a positive integer.

In one subembodiment of the above embodiment, K2 is equal to 1.

In one subembodiment of the above embodiment, K2 is greater than 1.

In one subembodiment of the above embodiment, the K2 given signal(s) comprises(comprise) an uplink reference signal.

In one subembodiment of the above embodiment, the K2 given signal(s) comprises(comprise) a downlink reference signal.

In one subembodiment of the above embodiment, a third given signal is a downlink reference signal in the K2 given signal(s), and the third given signal and the second reference signal resource are QCLed; the first node uses a same spatial-domain filter to receive the third given signal and transmit the second signal.

In one reference embodiment of the above subembodiment, the second reference signal resource is a downlink reference signal resource.

In one reference embodiment of the above subembodiment, the third given signal comprises a CSI-RS or an SS/PBCH block.

In one reference embodiment of the above subembodiment, a QCL type between the third given signal and the second reference signal resource comprises TypeD.

In one subembodiment of the above embodiment, a third given signal is a downlink reference signal in the K2 given signal(s), and the first node uses a same spatial filter to receive the third given signal and transmit a reference signal in the second reference signal resource; the first node uses a same spatial-domain filter to receive the third given signal and transmit the second signal.

In one reference embodiment of the above subembodiment, the second reference signal resource is a downlink reference signal resource.

In one subembodiment of the above embodiment, a fourth given signal is an uplink reference signal in the K2 given signal(s), and the first node uses a same spatial filter to transmit the fourth given signal and transmit or receive a reference signal in the second reference signal resource; the first node uses a same spatial-domain filter to transmit the fourth reference signal and the second signal.

In one reference embodiment of the above subembodiment, the fourth given signal comprises an SRS.

In one subembodiment of the above embodiment, a fourth given signal is an uplink reference signal in the K2 given signal(s), the fourth given signal comprises an SRS, the fourth given signal is transmitted in a fourth given SRS resource; the first node uses a same spatial filter to transmit the fourth given signal and transmit or receive a reference signal in the second reference signal resource; the first node uses an antenna port same as an SRS port of the fourth given SRS resource to transmit the second signal.

In one subembodiment of the above embodiment, a fourth given signal is an uplink reference signal in the K2 given signal(s), the fourth given signal comprises an SRS, the fourth given signal is transmitted in a fourth given SRS resource; the first node uses a same spatial filter to transmit the fourth given signal and transmit or receive a reference signal in the second reference signal resource; the second signal uses a pre-coder same as the fourth given signal.

In one embodiment, the meaning of being QCLed with a reference signal resource comprises: being QCLed with a reference signal transmitted in the reference signal resource.

In one embodiment, the meaning of being QCLed with a reference signal resource comprises: being QCLed with a reference signal port of the reference signal resource.

In one embodiment, the meaning of being QCLed with a reference signal resource comprises: being QCLed with an antenna port of the reference signal resource.

### Embodiment 8

Embodiment 8 illustrates a schematic diagram of whether a first node transmits a second signal or drops transmitting a second signal in a third symbol group being related to whether a first reference signal resource and a second reference signal resource belong to a same reference signal resource group in M reference signal resource groups according to one embodiment of the present application, as shown in FIG. 8.

In one embodiment, when the first reference signal resource and the second reference signal resource belong to a same reference signal resource group in the M reference signal resource groups, the first node drops transmitting the second signal in the third symbol group; when the first reference signal resource and the second reference signal resource respectively belong to different reference signal resource groups in the M reference signal resource groups, the first node transmits the second signal in the third symbol group.

In one embodiment, if the first reference signal resource and the second reference signal resource belong to a same reference signal resource group in the M reference signal resource groups, the first node drops transmitting the second signal in the third symbol group; if the first reference signal resource and the second reference signal resource respectively belong to different reference signal resource groups in the M reference signal resource groups, the first node transmits the second signal in the third symbol group.

### Embodiment 9

Embodiment 9 illustrates a schematic diagram of M reference signal resources and M reference signal resource groups according to one embodiment of the present application, as shown in FIG. 9. In embodiment 9, the M reference signal resources correspond one-to-one with the M reference signal resource groups, and any of the M reference signal resources is used by the first node to determine a spatial relation of each reference signal resource in a corresponding reference signal resource group. In FIG. 9, indexes of the M reference signal resources are respectively #0, . . . , #(M−1); indexes of the M reference signal resource groups are respectively #0, . . . , #(M−1).

In one embodiment, any of the M reference signal resources comprises one of a CSI-RS resource, an SS/PBCH block resource, or an SRS resource.

In one embodiment, any of the M reference signal resources is one of a CSI-RS resource, an SS/PBCH block resource, or an SRS resource.

In one embodiment, any of the M reference signal resources comprises a CSI-RS resource, or an SS/PBCH block resource.

In one embodiment, any of the M reference signal resources is a CSI-RS resource, or an SS/PBCH block resource.

In one embodiment, any of the M reference signal resources comprises an SRS resource.

In one embodiment, any of the M reference signal resources is an SRS resource.

In one embodiment, the M reference signal resources are respectively identified by M reference signal resource identifiers, and any two of the M reference signal resource identifiers are not the same.

In one embodiment, any of the M reference signal resource identifiers comprises one of NZP-CSI-RS-ResourceId, SSB-Index, or SRS-ResourceId.

In one embodiment, any of the M reference signal resource identifiers comprises one of a CRI, an SSBRI, or an SRI.

In one embodiment, any two of the M reference signal resources are not QCLed.

In one embodiment, any two of the M reference signal resources are QCLed not corresponding to QCL type TypeD.

In one embodiment, the M reference signal resource groups respectively comprise M SRS resources; the higher-layer parameter ‘usage’ associated with the M SRS resources is set to either ‘codebook’ or ‘nonCodebook’.

In one embodiment, the M reference signal resource groups respectively comprise M SRS resources; the higher-layer parameter ‘usage’ associated with the M SRS resources is set to either ‘codebook’ or ‘nonCodebook’; any of the M reference signal resources is used to determine a spatial relation of each reference signal resource in a corresponding reference signal resource group.

In one embodiment, the M SRS resources are respectively identified by M SRS-ResourceIds, and the M SRS-ResourceIds are not equal to each other.

In one embodiment, the M SRS resources are configured by the first higher-layer parameter, and a name of the first higher-layer parameter comprises ‘srs-ResourceSet’.

In one subembodiment of the above embodiment, a name of the first higher-layer parameter comprises ‘srs-ResourceSetToAddModList’.

In one embodiment, the M reference signal resources are configurable.

In one embodiment, the M reference signal resources are configured by a higher-layer parameter.

In one embodiment, the M reference signal resources are configured by an RRC parameter.

In one embodiment, the M reference signal resources are configured by a MAC CE parameter.

### Embodiment 10

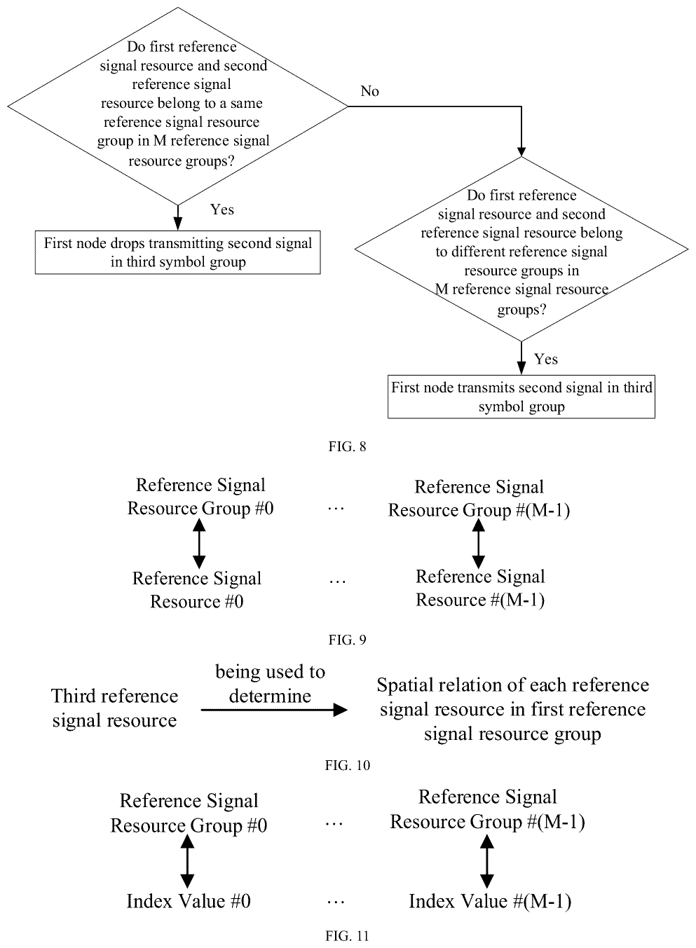

Embodiment 10 illustrates a schematic diagram of any of M reference signal resources being used to determine a spatial relation of each reference signal resource in a corresponding reference signal resource group according to one embodiment of the present application, as shown in FIG. 10. In embodiment 10, a first reference signal resource group is any of the M reference signal resource groups, and a third reference signal resource is a reference signal resource corresponding to the first reference signal resource group among the M reference signal resources; the third reference signal resource is used to determine a spatial relation of each reference signal resource in the first reference signal resource group.

In one embodiment, there exists a first target reference signal resource in the first reference signal resource group, and the third reference signal resource is used to directly determine a spatial relation of the first target reference signal resource.

In one embodiment, there exists a first target reference signal resource in the first reference signal resource group, and the first node uses a same spatial filter to receive or transmit a reference signal in the third reference signal resource and to transmit a reference signal in the first target reference signal resource.

In one embodiment, there exists a first target reference signal in the first reference signal resource group, and the first target reference signal resource and the third reference signal resource are QCLed.

In one subembodiment of the above embodiment, a QCL type corresponding to the first target reference signal resource and the third reference signal resource comprises TypeD.

In one embodiment, there exists a second target reference signal resource in the first reference signal resource group, and the third reference signal resource is used to indirectly determine a spatial relation of the second target reference signal resource.

In one embodiment, there exists a second target reference signal resource in the first reference signal resource group; the first node uses a same spatial filter to receive or transmit a reference signal in a first given reference signal resource and to transmit a reference signal in the second target reference signal resource; the third reference signal resource is used to determine a spatial relation of the first given reference signal resource.

In one subembodiment of the above embodiment, the first given reference signal resource and the third reference signal resource are QCLed.

In one subembodiment of the above embodiment, the first given reference signal resource and the third reference signal resource are QCLed and a corresponding QCL type comprises TypeD.

In one subembodiment of the above embodiment, the first node uses a same spatial filter to transmit a reference signal in a first given reference signal resource and to receive or transmit a reference signal in the third reference signal resource.

In one embodiment, there exists a second target reference signal resource in the first reference signal resource group; the second target reference signal resource and a first given reference signal resource are QCLed; the first given reference signal resource and the third reference signal resource are QCLed.

In one subembodiment of the above embodiment, the second target reference signal resource and the first given reference signal resource are QCLed, and a corresponding QCL type comprises TypeD; the first given reference signal resource and the third reference signal resource are QCLed and a corresponding QCL type comprises TypeD.

### Embodiment 11

Embodiment 11 illustrates a schematic diagram of M reference signal resource groups and M index values according to one embodiment of the present application, as shown in FIG. 11. In embodiment 11, any reference signal resource in the M reference signal resource groups corresponds to a first-type index, and the M reference signal resource groups correspond one-to-one with the M index values; the first-type indices corresponding to all reference signal resources in any of the M reference signal resource groups are equal to a corresponding index value; any two of the M index values are not equal. In FIG. 11, indexes of the M reference signal resource groups are respectively #0, . . . , #(M−1); indexes of the M index values are respectively #0, . . . #(M−1).

In one embodiment, the first-type index is a non-negative integer.

In one embodiment, the first-type index corresponding to a reference signal resource is configurable.

In one embodiment, the first-type index corresponding to a reference signal resource is configured by a higher-layer signaling.

In one embodiment, configuration information of a reference signal resource comprises the corresponding first-type index.

In one embodiment, the first-type index corresponding to a reference signal resource is comprised in configuration information of a reference signal resource set to which the reference signal resource belongs; the reference signal resource set comprises a CSI-RS resource set or an SRS resource set.

In one embodiment, the first-type index is related to a reference signal resource set to which a corresponding reference signal resource belongs; the reference signal resource set comprises a CSI-RS resource set or an SRS resource set.

In one embodiment, a reference signal resource set is configured by an NZP-CSI-RS-ResourceSet IE or by a higher-layer parameter ‘srs-ResourceSetToAddModList’.

In one embodiment, the first-type index is related to a spatial relation of a corresponding reference signal resource.

In one embodiment, the first-type index is related to a QCL relation of a corresponding reference signal resource.

In one embodiment, the first-type index is related to a TCI state of a corresponding reference signal resource.

In one embodiment, the first-type index is related to a cell associated with a corresponding reference signal resource.

In one embodiment, the first-type index is related to a BWP to which corresponding reference signal resources belong.

In one embodiment, the first-type index is related to an index of a CORESET (Control REsource SET) pool corresponding to a TCI state of a corresponding reference signal resource.

In one embodiment, one of a TCI state, QCL relation, or spatial relation of a reference signal resource is used to determine a value of the first-type index corresponding to the reference signal resource.

In one embodiment, the first-type index corresponding to a reference signal resource is equal to a TCI-StateId of a TCI state of the reference signal resource.

In one embodiment, the first-type index corresponding to a reference signal resource is equal to a SpatialRelationInfoId corresponding to a spatial relation of the reference signal resource.

In one embodiment, the first-type index corresponding to a reference signal resource is equal to an index of a CORESET pool corresponding to a TCI state of the reference signal resource.

In one embodiment, a cell associated with a reference signal resource is used to determine a value of the first-type index corresponding to the reference signal.

In one embodiment, a BWP to which a reference signal resource belongs is used to determine a value of the first-type index corresponding to the reference signal.

In one embodiment, the M index values are respectively M non-negative integers.

In one embodiment, the M index values are respectively M real numbers.

In one embodiment, the M index values are respectively M candidate values of the first-type index.

In one embodiment, M TCI state groups correspond one-to-one with the M reference signal resource groups, the M TCI state groups are respectively used to determine the M reference signal resource groups, the M TCI state groups respectively comprising at least one TCI state; the M TCI state groups correspond one-to-one with M CORESET pools; the M CORESET pools are used to determine the M index values, respectively.

In one subembodiment of the above embodiment, the M index values are equal to indexes of the M CORESET pools, respectively.

In one subembodiment of the above embodiment, M information sub-blocks are respectively used to activate the M TCI state groups, and the M information sub-blocks are respectively carried by M MAC CEs; the M information sub-blocks respectively indicate indexes of the M CORESET pools.

In one subembodiment of the above embodiment, a first reference signal resource group is any of the M reference signal resource groups; a first TCI state group is a TCI state group corresponding to the first reference signal resource group in the M TCI state groups; for any given reference signal resource in the first reference signal resource group, at least one TCI state in the first TCI state group is used to determine a spatial relation of the given reference signal resource, or a TCI state in the first TCI state group indicates the given reference signal resource.

In one reference embodiment of the above subembodiment, at least one TCI state in the first TCI state group is used to directly determine the spatial relation of the given reference signal resource.

In one reference embodiment of the above subembodiment, at least one TCI state in the first TCI state group is used to indirectly determine the spatial relation of the given reference signal resource.

In one reference embodiment of the above subembodiment, a source reference signal resource is used to determine a spatial relation of the given reference signal resource; a TCI state in the first TCI state group is used to determine a spatial relation of the source reference signal resources.

In one reference embodiment of the above subembodiment, a TCI state in the first TCI state group indicates the given reference signal resource.

In one subembodiment of the above embodiment, for any given reference signal resource in the M reference signal resource groups, a CORESET pool corresponding to a TCI state group of a reference signal resource group to which the given reference signal resource belongs is used to determine the first-type index corresponding to the given reference signal resource.

In one subembodiment of the above embodiment, for any given reference signal resource in the M reference signal resource groups, the first-type index corresponding to the given reference signal resource is equal to an index of a CORESET pool corresponding to a TCI state group corresponding to a reference signal resource group to which the given reference signal resource belongs.

### Embodiment 12

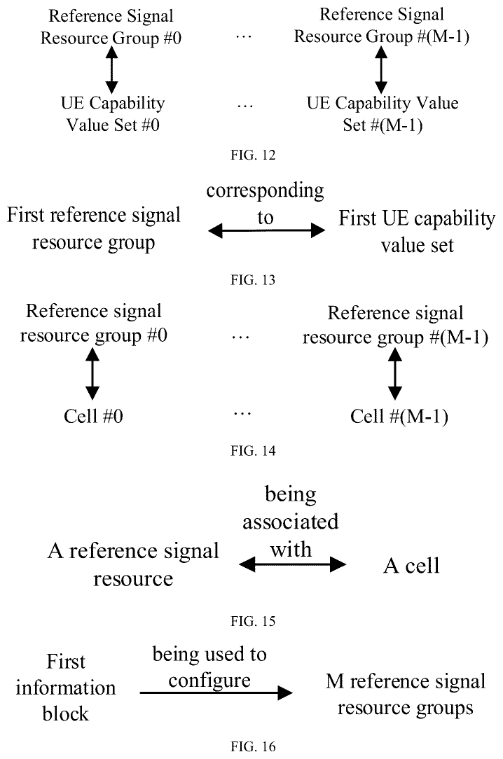

Embodiment 12 illustrates a schematic diagram of M reference signal resource groups and M UE capability value sets according to one embodiment of the present application, as shown in FIG. 12. In Embodiment 12, the M reference signal resource groups correspond one-to-one with the M UE capability value sets; at least one UE capability value in any two of the M UE capability value sets is different. In FIG. 12, indexes of the M reference signal resource groups are respectively #0, . . . , #(M−1); indexes of the M UE capability value sets are #0, . . . , #(M−1), respectively.

In one embodiment, the UE capability value set refers to: UE capability value set.

In one embodiment, the UE capability value set comprises at least one UE capability value.

In one embodiment, there exists one of the M UE capacity value sets only comprising one UE capacity value.

In one embodiment, any UE capacity value set in the M UE capacity value sets only comprises one UE capacity value.

In one embodiment, there exists one of the M UE capacity value sets comprising multiple UE capacity values.

In one embodiment, the M UE capability value sets comprise UE capability values of a same type.

In one embodiment, the M UE capability value sets comprise UE capability values of a same number.

In one embodiment, the M UE capability value sets comprise UE capability values of a same type and a same number.

In one embodiment, there exist two of the M UE capability value sets comprising UE capability values of different types or numbers.

In one embodiment, the UE capacity value set comprises: a maximum number of supported SRS ports.

In one embodiment, a UE capability value comprised in any of the M UE capability value sets is: a maximum number of supported SRS ports.

In one embodiment, maximum numbers of supported SRS ports comprised in any two of the M UE capability value sets are not equal.

In one embodiment, indexes of any two UE capability value sets in the M UE capability value sets are different.

### Embodiment 13

Embodiment 13 illustrates a schematic diagram of a first reference signal resource group corresponding to a first UE capability value set according to one embodiment of the present application, as shown in FIG. 13. In embodiment 13, a first reference signal resource group is any of the M reference signal resource groups, and a first UE capability value set is a UE capability value set corresponding to the first reference signal resource group in the M UE capability value sets; the meaning of the phrase that the M reference signal resource groups respectively correspond to M UE capability value sets comprises: each reference signal resource in the first reference signal resource group corresponds to the first UE capability value set.

In one embodiment, the meaning of the phrase that the M reference signal resource groups respectively correspond to M UE capability value sets comprises: all reference signal resources in any given reference signal resource group of the M reference signal resource groups correspond to a UE capability value set corresponding to the given reference signal resource group in the M UE capability value sets.

In one embodiment, the meaning of a reference signal resource corresponding to a UE capability value set comprises: an index of the UE capability value set and a reference signal resource identifier of the reference signal resource are fed back together.

In one embodiment, the meaning of a reference signal resource corresponding to a UE capability value set comprises: an index of the UE capability value set, a reference signal resource identifier of the reference signal resource, and an L1-RSRP (Reference Signal Received Power) are fed back together.

In one embodiment, the meaning of a reference signal resource corresponding to a UE capability value set comprises: an index of the UE capability value set, CRI or SSBRI of the reference signal resource, and an L1-RSRP are fed back together.

In one embodiment, the meaning of a reference signal resource corresponding to a UE capability value set comprises: a second given reference signal resource is used to determine a spatial relation of the reference signal resource, and an index of the UE capability value set and a reference signal resource identifier of the second given reference signal resource are fed back together.

In one subembodiment of the above embodiment, an index of the UE capability value set, the reference signal resource identifier of the second given reference signal resource, and an L1-RSRP are fed back together.

In one subembodiment of the above embodiment, the reference signal resource identifier of the second given reference signal resource comprises a CRI or an SSBRI.

In one subembodiment of the above embodiment, the reference signal resource and the second given reference signal resource are QCLed.

In one subembodiment of the above embodiment, the reference signal resource and the second given reference signal resource are QCLed and a corresponding QCL type comprises TypeD.

In one subembodiment of the above embodiment, the first node uses a same spatial filter to receive a reference signal in the second given reference signal resource and to transmit a reference signal in the reference signal resource.

In one subembodiment of the above embodiment, the first node uses a same spatial filter to transmit a reference signal in the second given reference signal resource and to transmit reference signals in the reference signal resource.

In one subembodiment of the above embodiment, the second given reference signal resource is used to determine a spatial relation of another reference signal resource different from the reference signal resource, and the another reference signal resource is used to determine the spatial relation of the reference signal resource.

In one embodiment, the meaning of a reference signal resource corresponding to a UE capability value set comprises: the reference signal resource is an SRS resource, and a number of SRS port(s) of the reference signal resource is not greater than a maximum number of supported SRS ports comprised in the UE capability value set.

### Embodiment 14

Embodiment 14 illustrates a schematic diagram of M reference signal resource groups and M cells according to one embodiment of the present application, as shown in FIG. 14. In embodiment 14, the M reference signal resource groups correspond one-to-one with the M cells, and all reference signal resources in any of the M reference signal resource groups are associated with a corresponding cell. In FIG. 14, indexes of the M reference signal resource groups are respectively #0, . . . , #(M−1); indexes of the M cells are respectively #0, . . . #(M−1).

In one embodiment, PCIs (Physical Cell Identities) of any two of the M cells are different.

In one embodiment, any two of the M cells correspond to different CellIdentity.

In one embodiment, any two of the M cells correspond to different SCellIndex.

In one embodiment, any two of the M cells correspond to different ServCellIndex.

In one embodiment, the M cells comprise a first cell and a second cell.

In one subembodiment of the above embodiment, the first cell is added by the first node, and the second cell is not added by the first node.

In one subembodiment of the above embodiment, the first node executes SCell addition for the first cell.

In one subembodiment of the above embodiment, the first node does not perform auxiliary serving cell addition for the second cell.

In one subembodiment of the above embodiment, a sCellToAddModList newly received by the first node comprises the first cell.

In one subembodiment of the above embodiment, a sCellToAddModList newly received by the first node does not comprise the second cell.

In one subembodiment of the above embodiment, a sCellToAddModList or a sCellToAddModListSCG newly received by the first node comprises the first cell.

In one subembodiment of the above embodiment, a sCellToAddModList and a sCellToAddModListSCG newly received by the first node do not comprise the second cell.

In one subembodiment of the above embodiment, the first node is allocated a SCellIndex for the first cell.

In one subembodiment of the above embodiment, the first node is not assigned a SCellIndex for the second cell.

In one subembodiment of the above embodiment, the first node is assigned a ServCellIndex for the first cell.

In one subembodiment of the above embodiment, the first node is not assigned a ServCellIndex for the second cell.

In one subembodiment of the above embodiment, the first node is assigned an SCellIndex or ServCellIndex for the first cell.

In one subembodiment of the above embodiment, the first node is not assigned SCellIndex and ServCellIndex for the second cell.

In one subembodiment of the above embodiment, an RRC connection is established between the first node and the first cell.

In one subembodiment of the above embodiment, there is no RRC connection between the first node and the second cell.

In one subembodiment of the above embodiment, a C (Cell)-RNTI (Radio Network Temporary Identifier) of the first node is assigned by the first cell.

In one subembodiment of the above embodiment, a C-RNTI of the first node is not assigned by the second cell.

In one subembodiment of the above embodiment, the first cell and the second cell are each a physical cell.

In one subembodiment of the above embodiment, the first cell is a serving cell of the first node.

In one subembodiment of the above embodiment, the second cell is a serving cell of the first node.

In one subembodiment of the above embodiment, the second cell is not a serving cell of the first node.

In one subembodiment of the above embodiment, the second cell provides extra resources above the first cell.

In one subembodiment of the above embodiment, the second cell is a candidate cell configured for L1/L2 mobility.

In one subembodiment of the above embodiment, the first cell and the second cell are a same frequency.

In one subembodiment of the above embodiment, the first cell and the second cell are on different frequency.

In one subembodiment of the above embodiment, the second cell is a mobile management cell configured for the first cell.

In one subembodiment of the above embodiment, different RNTIs are used to determine a scrambling code sequence of a physical-layer channel transmitted or received by the first node in the first cell and a scrambling code sequence of a physical-layer channel transmitted or received in the second cell; the physical-layer channel comprises one or more of PDCCH, PDSCH, PUCCH, or PUSCH.

In one subembodiment of the above embodiment, a CRC (Cyclic Redundancy Check) of a PDCCH received by the first node in the first cell and a CRC of a PDCCH received in the second cell are scrambled by different RNTIs.

In one subembodiment of the above embodiment, a maintenance base station of the first cell and a maintenance base station of the second cell are a same base station.

In one subembodiment of the above embodiment, a maintenance base station of the first cell and a maintenance base station of the second cell are different base stations.

In one subembodiment of the above embodiment, M is equal to 2, and the M cells consist of the first cell and the second cell.

In one embodiment, the SCellIndex is a positive integer not greater than 31.

In one embodiment, the ServCellIndex is a non-negative integer not greater than 31.

### Embodiment 15

Embodiment 15 illustrates a schematic diagram of a reference signal resource being associated with a cell according to one embodiment of the present application, as shown in FIG. 15. In embodiment 15, the reference signal resource is any reference signal resource in any of the M reference signal resource groups, and the cell is a cell corresponding to a reference signal resource group to which the reference signal resource belongs among the M cells.

In one embodiment, the meaning of a reference signal being associated with a cell comprises: a PCI of the cell is used to generate the reference signal.

In one embodiment, the meaning of a reference signal being associated with a cell comprises: the reference signal is QCLed with an SS/PBCH block of the cell.

In one embodiment, the meaning of a reference signal being associated with a cell comprises: the reference signal is QCLed with an SS/PBCH block of the cell and a corresponding QCL type comprises TypeD.

In one embodiment, the meaning of a reference signal being associated with a cell comprises: the reference signal is transmitted by a cell.

In one embodiment, the meaning of a reference signal being associated with a cell comprises: radio resources occupied by the reference signal are indicated by a configuration signaling, an RLC bearer that the configuration signaling goes through is configured by a CellGroupConfig 1E, and a Special Cell (SpCell) configured by the CellGroupConfig 1E comprises the cell.

In one subembodiment of the above embodiment, the configuration signaling comprises an RRC signaling.

In one subembodiment of the above embodiment, the radio resources comprise time-frequency resources.

In one subembodiment of the above embodiment, the radio resources comprise an RS sequence.

In one subembodiment of the above embodiment, the radio resources comprise code-domain resources.

### Embodiment 16

Embodiment 16 illustrates a schematic diagram of M reference signal resource groups respectively being configurable according to one embodiment of the present application, as shown in FIG. 16. In Embodiment 16, a first information block is used to configure the M reference signal resource groups.

In one embodiment, the first information block is carried by a higher-layer signaling.

In one embodiment, the first information block is carried by an RRC signaling.

In one embodiment, the first information block is carried by a MAC CE.

In one embodiment, the first information block comprises M information sub-blocks, and the M information sub-blocks are respectively used to configure M reference signal resource groups.

In one embodiment, the M information sub-blocks are carried by a same higher-layer signaling.

In one embodiment, the M information sub-blocks are carried by M different higher-layer signalings, respectively.

In one embodiment, there exist two information sub-blocks in the M information sub-blocks being carried by a same higher-layer signaling.

In one embodiment, there exist two information sub-blocks in the M information sub-blocks being carried by different higher-layer signalings.

In one embodiment, the M reference signal resource groups are respectively configured by a higher-layer signaling.

In one embodiment, the M reference signal resource groups are respectively configured by an RRC signaling.

In one embodiment, the M reference signal resource groups are respectively configured by a MAC CE.

In one embodiment, the M reference signal resource groups are respectively configured by M different higher-layer signalings.

In one embodiment, the M reference signal resource groups are respectively configured by M different RRC signalings.

In one embodiment, the M reference signal resource groups are respectively configured by M different MAC CEs.

In one embodiment, the M reference signal resource groups are configured by a same higher-layer signaling.

In one embodiment, the M reference signal resource groups are configured by a same RRC signaling.

In one embodiment, the M reference signal resource groups are configured by a same MAC CE.

In one embodiment, there exist two reference signal resource groups in the M reference signal resource groups being configured by a same higher-layer signaling.

In one embodiment, there exist two reference signal resource groups in the M reference signal resource groups being configured by different higher-layer signalings.

In one embodiment, the M reference signal resource groups and M TCI state groups correspond one-to-one, and any TCI state group in the M TCI state groups comprises at least one TCI state; for any given reference signal resource in any given reference signal resource group among the M reference signal resource groups, the given reference signal resource comprises a reference signal resource indicated by a TCI state in a TCI state group corresponding to the given reference signal resource group, or a spatial relation of the given reference signal resource is determined by a TCI state in a TCI state group corresponding to the given reference signal resource group; the M TCI state groups are configurable.

In one subembodiment of the above embodiment, the given reference signal resource group comprises reference signal resources indicated by each TCI state in a corresponding TCI state group.

In one subembodiment of the above embodiment, the M TCI state groups are TCI state groups activated for M CORESET pools.

In one embodiment, M information sub-blocks respectively indicate the M reference signal resource groups, and the M information sub-blocks respectively indicate M CORESET pools, and the M CORESET pools correspond one-to-one with the M reference signal resource groups.

In one subembodiment of the above embodiment, the M CORESET pools and M TCI state groups correspond one-to-one, and any TCI state group in the M TCI state groups comprises at least one TCI state; any of the M information sub-blocks indicates one of the M CORESET pools and each TCI state in a TCI state group corresponding to the CORESET pool; the M reference signal resource groups correspond one-to-one with the M TCI state groups; for any given reference signal resource in any given reference signal resource group among the M reference signal resource groups, the given reference signal resource comprises a reference signal resource indicated by a TCI state in a TCI state group corresponding to the given reference signal resource group, or a spatial relation of the given reference signal resource is determined by a TCI state in a TCI state group corresponding to the given reference signal resource group.

In one subembodiment of the above embodiment, the M information sub-blocks are respectively carried by M MAC CEs.

In one subembodiment of the above embodiment, the given reference signal resource group comprises reference signal resources indicated by each TCI state in a corresponding TCI state group.

In one embodiment, any of the M reference signal resource groups consists of reference signal resources indicated by each TCI state in a corresponding TCI state group.

### Embodiment 17

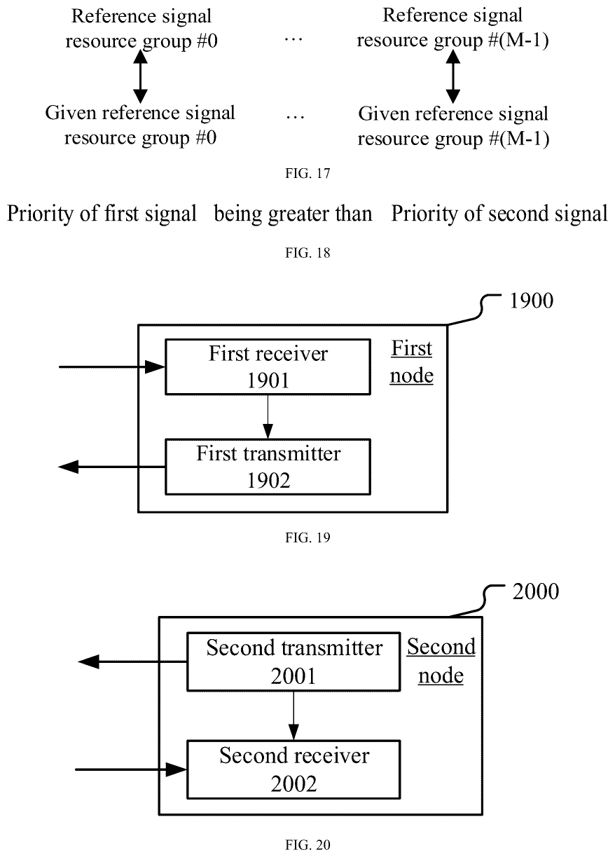

Embodiment 17 illustrates a schematic diagram of M reference signal resource groups and M given reference signal resource groups according to one embodiment of the present application, as shown in FIG. 17. In embodiment 17, M given reference signal resource groups correspond one-to-one with the M given reference signal resource groups, and any given reference signal resource group in the M given reference signal resource groups comprises at least one reference signal resource; the M given reference signal resource groups are respectively configurable. In FIG. 17, indexes of the M reference signal resource groups are respectively #0, . . . , #(M−1); indexes of the M given reference signal resource groups are respectively #0, . . . , #(M−1).

In one embodiment, the M reference signal resource groups are respectively the M given reference signal resource groups.

In one embodiment, a spatial relation of any reference signal resource in any of the M reference signal resource groups is determined by a reference signal resource in a corresponding given reference signal resource group.

In one embodiment, the M given reference signal resource groups are configured by a second higher-layer parameter.

In one embodiment, a name of the second higher-layer parameter comprises ‘RadioLinkMonitoring’.

In one embodiment, a name of the second higher-layer parameter comprises ‘failureDetectionResources’.

In one embodiment, a name of the second higher-layer parameter comprises ‘failureDetectionResourcesToAddModList’.

In one embodiment, a name of the second higher-layer parameter comprises ‘BeamFailureDetection’.

In one embodiment, a name of the second higher-layer parameter comprises ‘BeamFailureDetectionSet’.

In one embodiment, a name of the second higher-layer parameter comprises ‘BeamFailureRecovery’.

In one embodiment, a name of the second higher-layer parameter comprises ‘BeamFailureRecoveryConfig’.

In one embodiment, a name of the second higher-layer parameter comprises ‘candidateBeamRSList’.

In one embodiment, the M given reference signal resource groups are respectively configured by M third higher-layer parameters.

In one embodiment, names of the M third higher-layer parameters all comprise ‘failureDetectionResources’.

In one embodiment, names of the M third higher-layer parameters all comprise ‘failureDetectionResourcesToAddModList’.

In one embodiment, names of the M third higher-layer parameters all comprise ‘BeamFailureDetection’.

In one embodiment, names of the M third higher-layer parameters all comprise ‘BeamFailureDetectionSet’.

In one embodiment, a name of one of the M third higher-layer parameters comprises ‘failureDetectionResources’, and a name of another one of the M third higher-layer parameters comprises ‘BeamFailureDetection’.

In one embodiment, a name of one of the M third higher-layer parameters comprises ‘failureDetectionResourcesToAddModList’, and a name of another third higher-layer parameter in the M third higher-layer parameters comprises ‘BeamFailureDetectionSet’.

In one embodiment, names of the M third higher-layer parameters all comprise ‘candideBeamRSList’.

In one embodiment, a name of one of the M third higher-layer parameters comprises ‘candidateBeamRSList1’, and a name of another one of the M third higher-layer parameters comprises ‘candidateBeamRSList2’.

In one embodiment, M is equal to 2, and the M given reference signal resource groups are q̅_{0,0} and q̅_{0,1}, respectively.

In one embodiment, M is equal to 2, and the M given reference signal resource groups are q̅_{1,0} and q̅_{1,1}, respectively.

In one embodiment, for the specific definition of ′q̅_{0,0} and ′q̅_{0,1}, refer to 3GPP TS38.213.

In one embodiment, for the specific definition of ′q̅_{1,0} and ′q̅_{1,1}, refer to 3GPP TS38.213.

In one embodiment, M is equal to 2, and one of the M given reference signal resource groups comprises reference signal resources indicated by a TCI state of a first CORESET group, while the another given reference signal resource group in the M given reference signal resource group comprises a reference signal resource indicated by a TCI state of a second CORESET group; the first CORESET group and the second CORESET group respectively comprise at least one CORESET; the first CORESET group is configured with coresetPoolIndex equal to 0, or the first CORESET group is not configured with coresetPoolIndex; the second CORESET group is configured with coresetPoolIndex equal to 1.

### Embodiment 18

Embodiment 18 illustrates a schematic diagram of a priority of a first signal being higher than a priority of a second signal according to one embodiment of the present application, as shown in FIG. 18.

In one embodiment, the meaning that a priority of the first signal is higher than a priority of the second signal comprises: a priority index corresponding to the first signal is greater than a priority index corresponding to the second signal.

In one embodiment, the meaning that a priority of the first signal is higher than a priority of the second signal comprises: a priority index corresponding to the first signal is less than a priority index corresponding to the second signal.

In one embodiment, the meaning that a priority of the first signal is higher than a priority of the second signal comprises: the first signal comprises PUSCH transmission corresponding to priority index 1, and the second signal comprises PUSCH transmission corresponding to priority index 0.

In one embodiment, the meaning that a priority of the first signal is higher than a priority of the second signal comprises: the first signal comprises PUCCH transmission corresponding to priority index 1, and the second signal comprises PUCCH transmission corresponding to priority index 0.

In one embodiment, the meaning that a priority of the first signal is higher than a priority of the second signal comprises: the first signal comprises PUSCH transmission corresponding to priority index 0, and the second signal comprises PUSCH transmission corresponding to priority index 1.

In one embodiment, the meaning that a priority of the first signal is higher than a priority of the second signal comprises: the first signal comprises PUCCH transmission corresponding to priority index 0, and the second signal comprises PUCCH transmission corresponding to priority index 1.

In one embodiment, the meaning that a priority of the first signal is higher than a priority of the second signal comprises: the second signal comprises an SRS, and the first signal comprises PUSCH transmission.

In one embodiment, the meaning that a priority of the first signal is higher than a priority of the second signal comprises: the second signal comprises an SRS, and the first signal comprises PUSCH transmission corresponding to priority index 0.

In one embodiment, the meaning that a priority of the first signal is higher than a priority of the second signal comprises: the second signal comprises an SRS, and the first signal comprises PUCCH transmission corresponding to priority index 0.

In one embodiment, the meaning that a priority of the first signal is higher than a priority of the second signal comprises: the second signal comprises an SRS, and the first signal comprises PUSCH transmission corresponding to priority index 1.

In one embodiment, the meaning that a priority of the first signal is higher than a priority of the second signal comprises: the second signal comprises an SRS, and the first signal comprises PUCCH transmission corresponding to priority index 1.

In one embodiment, the meaning that a priority of the first signal is higher than a priority of the second signal comprises: the second signal comprises a periodic SRS or semi-persistent SRS, and the first signal comprises PUCCH transmission.

In one embodiment, the meaning that a priority of the first signal is higher than a priority of the second signal comprises: the second signal comprises a periodic or semi-persistent SRS, and the first signal comprises PUCCH transmission carrying only CSI reporting, or only L1-RSRP reporting, or only L1-SSINR (signal-to-noise and interference ratio) reporting.

In one embodiment, the meaning that a priority of the first signal is higher than a priority of the second signal comprises: the second signal comprises a periodic, semi-persistent, or aperiodic SRS, and the first signal comprises PUCCH transmission carrying at least one of HARQ-ACK (Acknowledgement), link recovery request, or SR (Scheduling Request).

In one embodiment, the meaning that a priority of the first signal is higher than a priority of the second signal comprises: the second signal comprises PUCCH, and the PUCCH carries semi-persistent or periodic CSI reporting, or only semi-persistent or periodic L1-RSRP reporting, or only L1-SINR reporting; the first signal comprises an aperiodic SRS.

In one embodiment, the meaning that a priority of the first signal is higher than a priority of the second signal comprises: the second signal comprises a periodic SRS, and the first signal comprises a semi-persistent or aperiodic SRS.

In one embodiment, the meaning that a priority of the first signal is higher than a priority of the second signal comprises: the second signal comprises a semi-persistent SRS, and the first signal comprises an aperiodic SRS.

### Embodiment 19

Embodiment 19 illustrates a structure block diagram of a processor in a first node according to one embodiment of the present application, as shown in FIG. 19. In FIG. 19, a processor 1900 in a first node comprises a first receiver 1901 and a first transmitter 1902.

In Embodiment 19, a first receiver 1901 receives a first signaling and a second signaling; a first transmitter 1902 transmits a first signal in a first symbol group; and a first transmitter 1902 transmits a second signal in a third symbol group, or drops transmitting a second signal in a third symbol group.

in embodiment 19, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first transmitter transmits the second signal or drops transmitting the second signal in the third symbol group is related to whether the first reference signal resource and the second reference signal resource belong to a same reference signal resource group in M reference signal resource groups, M being a positive integer greater than 1.

In one embodiment, M reference signal resources correspond one-to-one with the M reference signal resource groups, and any of the M reference signal resources is used to determine a spatial relation of each reference signal resource in a corresponding reference signal resource group.

In one embodiment, any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal.

In one embodiment, the M reference signal resource groups correspond to M UE capability value sets, respectively; at least one UE capability value in any two of the M UE capability value sets is different.

In one embodiment, the M reference signal resource groups correspond one-to-one with M cells, and all reference signal resources in any of the M reference signal resource groups are associated with a corresponding cell.

In one embodiment, the M reference signal resource groups are respectively configurable.

In one embodiment, a priority of the first signal is higher than a priority of the second signal.

In one embodiment, the first node is a UE.

In one embodiment, the first node is a relay node.

In one embodiment, the first transmitter 1902 judges whether to transmit the second signal in the third symbol group.

In one embodiment, the first transmitter 1902 transmits the second signal in the third symbol group.

In one embodiment, the first transmitter 1902 drops transmitting the second signal in the third symbol group.

In one embodiment, the first signal and the second signal belong to a same BWP or a same carrier; the first signal comprises PUSCH or PUSCH transmission, the second signal comprises an SRS, or, the first signal comprises an SRS, the second signal comprises PUCCH transmission, or, the first signal comprises an SRS, the second signal comprises an SRS.

In one embodiment, any symbol in the second symbol group belongs to the first symbol group, or there is a symbol in the second symbol group not belonging to the first symbol group; the third symbol group consists of an overlapping part of the first symbol group and the second symbol group, or the third symbol group is the second symbol group.

In one embodiment, the second signal comprises PUSCH transmission, and the third symbol group is the second symbol group; or, the second signal comprises PUCCH transmission, and the third symbol group is the second symbol group; or, the second signal comprises an SRS, and the third symbol group consists of all symbols belonging to the first symbol group in the second symbol group.

In one embodiment, the first receiver 1901 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1902 comprises at least one of the antenna 452, the transmitter 454, the transmitting processor 468, the multi-antenna transmitting processor 457, the controller/processor 459, the memory 460, or the data source 467 in Embodiment 4.

### Embodiment 20

Embodiment 20 illustrates a structure block diagram of a processor in a second node according to one embodiment of the present application, as shown in FIG. 20. In FIG. 20, a processor 2000 in a second node comprises a second transmitter 2001 and a second receiver 2002.

In Embodiment 20, a second transmitter 2001 transmits a first signaling and a second signaling; a second receiver 2002 receives a first signal in a first symbol group; and a second receiver 2002 receives a second signal in a third symbol group, or drops receiving a second signal in a third symbol group.

In embodiment 20, the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; a transmitter of the first signal transmits the second signal or drops transmitting the second signal in the third symbol group; whether a transmitter of the first node transmits the second signal or drops transmitting the second signal in the third symbol group is related to whether the first reference signal resource and the second reference signal resource belong to a same reference signal resource group in M reference signal resource groups, M being a positive integer greater than 1.

In one embodiment, M reference signal resources correspond one-to-one with the M reference signal resource groups, and any of the M reference signal resources is used to determine a spatial relation of each reference signal resource in a corresponding reference signal resource group.

In one embodiment, any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal.

In one embodiment, the M reference signal resource groups correspond to M UE capability value sets, respectively; at least one UE capability value in any two of the M UE capability value sets is different.

In one embodiment, the M reference signal resource groups correspond one-to-one with M cells, and all reference signal resources in any of the M reference signal resource groups are associated with a corresponding cell.

In one embodiment, the M reference signal resource groups are respectively configurable.

In one embodiment, a priority of the first signal is higher than a priority of the second signal.

In one embodiment, the second node is a base station.

In one embodiment, the second node is a UE.

In one embodiment, the second node is a relay node.

In one embodiment, the second receiver 2002 judges whether the second signal is received in the third symbol group.

In one embodiment, the second receiver 2002 receives the second signal in the third symbol group.

In one embodiment, the second receiver 2002 drops receiving the second signal in the third symbol group.

In one embodiment, the first signal and the second signal belong to a same BWP or a same carrier; the first signal comprises PUSCH or PUSCH transmission, the second signal comprises an SRS, or, the first signal comprises an SRS, the second signal comprises PUCCH transmission, or, the first signal comprises an SRS, the second signal comprises an SRS.

In one embodiment, any symbol in the second symbol group belongs to the first symbol group, or there is a symbol in the second symbol group not belonging to the first symbol group; the third symbol group consists of an overlapping part of the first symbol group and the second symbol group, or the third symbol group is the second symbol group.

In one embodiment, the second signal comprises PUSCH transmission, and the third symbol group is the second symbol group; or, the second signal comprises PUCCH transmission, and the third symbol group is the second symbol group; or, the second signal comprises an SRS, and the third symbol group consists of all symbols belonging to the first symbol group in the second symbol group.

In one embodiment, the second transmitter 2001 comprises at least one of the antenna 420, the transmitter 418, the transmitting processor 416, the multi-antenna transmitting processor 471, the controller/processor 475, or the memory 476 in Embodiment 4.

In one embodiment, the second receiver 2002 comprises at least one of the antenna 420, the receiver 418, the receiving processor 470, the multi-antenna receiving processor 472, the controller/processor 475, the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling and a second signaling;
a first transmitter, transmitting a first signal in a first symbol group, the first signal being transmitted in PUSCH; and
the first transmitter, transmitting a second signal in a third symbol group, or dropping transmitting a second signal in a third symbol group; a physical-layer channel corresponding to the second signal comprising PUSCH;
wherein the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first transmitter transmits the second signal or drops transmitting the second signal in the third symbol group is related to whether the first reference signal resource and the second reference signal resource belong to a same reference signal resource group in M reference signal resource groups, M being a positive integer greater than 1; when the first reference signal resource and the second reference signal resource belong to a same reference signal resource group in the M reference signal resource groups, the first transmitter drops transmitting the second signal in the third symbol group; when the first reference signal resource and the second reference signal resource respectively belong to different reference signal resource groups in the M reference signal resource groups, the first transmitter transmits the second signal in the third symbol group.

2. The first node according to claim 1, wherein M reference signal resources correspond one-to-one with the M reference signal resource groups, and any of the M reference signal resources is used to determine a spatial relation of each reference signal resource in a corresponding reference signal resource group.

3. The first node according to claim 1, wherein any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal; the first-type index corresponding to a reference signal resource is comprised in configuration information of a reference signal resource set to which the reference signal resource belongs; the reference signal resource set comprises an SRS resource set, and any reference signal resource in the M reference signal resource groups is an SRS resource.

4. The first node according to claim 1, wherein M TCI state groups correspond one-to-one with the M reference signal resource groups, and the M TCI state groups respectively comprise a TCI state; the M TCI state groups correspond one-to-one with M CORESET pools; a first reference signal resource group is any of the M reference signal resource groups; a first TCI state group is a TCI state group corresponding to the first reference signal resource group in the M TCI state groups; for any given reference signal resource in the first reference signal resource group, a TCI state in the first TCI state group is used to determine a spatial relation of the given reference signal resource, or a TCI state in the first TCI state group indicates the given reference signal resource.

5. The first node according to claim 1, wherein the first signal and the second signal belong to a same carrier, the M reference signal resource groups correspond one-to-one with M cells, and all reference signal resources in any of the M reference signal resource groups are associated with a corresponding cell.

6. The first node according to claim 1, wherein the first reference signal resource is used to determine a spatial relation of the first signal, and the second reference signal resource is used to determine a spatial relation of the second signal, and the spatial relation comprises a spatial domain transmission filter;
or, the first reference signal resource comprises an SRS resource, and the first node uses antenna port(s) same as SRS port(s) of the first reference signal resource to transmit the first signal, the second reference signal resource comprises an SRS resource, and the first node uses antenna port(s) same as SRS port(s) of the second reference signal resource to transmit the second signal.

7. The first node according to claim 1, wherein a priority of the first signal is higher than a priority of the second signal.

8. A second node for wireless communications, comprising:
a second transmitter, transmitting a first signaling and a second signaling; and
a second receiver, receiving a first signal in a first symbol group, the first signal being transmitted in PUSCH; and
the second receiver, receiving a second signal in a third symbol group, or dropping receiving a second signal in a third symbol group; a physical-layer channel corresponding to the second signal comprising PUSCH;
wherein the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; a transmitter of the first signal transmits the second signal or drops transmitting the second signal in the third symbol group; whether the transmitter of the first signal transmits the second signal or drops transmitting the second signal in the third symbol group is related to whether the first reference signal resource and the second reference signal resource belong to a same reference signal resource group in M reference signal resource groups, M being a positive integer greater than 1; when the first reference signal resource and the second reference signal resource belong to a same reference signal resource group in the M reference signal resource groups, the transmitter of the first signal drops transmitting the second signal in the third symbol group; when the first reference signal resource and the second reference signal resource respectively belong to different reference signal resource groups in the M reference signal resource groups, the transmitter of the first signal transmits the second signal in the third symbol group.

9. The second node according to claim 8, wherein any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal; the first-type index corresponding to a reference signal resource is comprised in configuration information of a reference signal resource set to which the reference signal resource belongs; the reference signal resource set comprises an SRS resource set, and any reference signal resource in the M reference signal resource groups is an SRS resource;
or, M TCI state groups correspond one-to-one with the M reference signal resource groups, and the M TCI state groups respectively comprise a TCI state; the M TCI state groups correspond one-to-one with M CORESET pools; a first reference signal resource group is any of the M reference signal resource groups; a first TCI state group is a TCI state group corresponding to the first reference signal resource group in the M TCI state groups; for any given reference signal resource in the first reference signal resource group, a TCI state in the first TCI state group is used to determine a spatial relation of the given reference signal resource, or a TCI state in the first TCI state group indicates the given reference signal resource.

10. The second node according to claim 8, wherein the first signal and the second signal belong to a same carrier, the M reference signal resource groups correspond one-to-one with M cells, and all reference signal resources in any of the M reference signal resource groups are associated with a corresponding cell.

11. A method in a first node for wireless communications, comprising:
receiving a first signaling and a second signaling;
transmitting a first signal in a first symbol group, the first signal being transmitted in PUSCH; and
transmitting a second signal in a third symbol group, or dropping transmitting a second signal in a third symbol group; a physical-layer channel corresponding to the second signal comprising PUSCH;
wherein the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; whether the first node transmits the second signal or drops transmitting the second signal in the third symbol group is related to whether the first reference signal resource and the second reference signal resource belong to a same reference signal resource group in M reference signal resource groups, M being a positive integer greater than 1; when the first reference signal resource and the second reference signal resource belong to a same reference signal resource group in the M reference signal resource groups, the first node drops transmitting the second signal in the third symbol group; when the first reference signal resource and the second reference signal resource respectively belong to different reference signal resource groups in the M reference signal resource groups, the first node transmits the second signal in the third symbol group.

12. The method according to claim 11, wherein M reference signal resources correspond one-to-one with the M reference signal resource groups, and any of the M reference signal resources is used to determine a spatial relation of each reference signal resource in a corresponding reference signal resource group.

13. The method according to claim 11, wherein any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal; the first-type index corresponding to a reference signal resource is comprised in configuration information of a reference signal resource set to which the reference signal resource belongs; the reference signal resource set comprises an SRS resource set, and any reference signal resource in the M reference signal resource groups is an SRS resource.

14. The method according to claim 11, wherein M TCI state groups correspond one-to-one with the M reference signal resource groups, and the M TCI state groups respectively comprise a TCI state; the M TCI state groups correspond one-to-one with M CORESET pools; a first reference signal resource group is any of the M reference signal resource groups; a first TCI state group is a TCI state group corresponding to the first reference signal resource group in the M TCI state groups; for any given reference signal resource in the first reference signal resource group, a TCI state in the first TCI state group is used to determine a spatial relation of the given reference signal resource, or a TCI state in the first TCI state group indicates the given reference signal resource.

15. The method according to claim 11, wherein the first signal and the second signal belong to a same carrier, the M reference signal resource groups correspond one-to-one with M cells, and all reference signal resources in any of the M reference signal resource groups are associated with a corresponding cell.

16. The method according to claim 11, wherein the first reference signal resource is used to determine a spatial relation of the first signal, and the second reference signal resource is used to determine a spatial relation of the second signal, and the spatial relation comprises a spatial domain transmission filter;
or, the first reference signal resource comprises an SRS resource, and the first node uses antenna port(s) same as SRS port(s) of the first reference signal resource to transmit the first signal, the second reference signal resource comprises an SRS resource, and the first node uses antenna port(s) same as SRS port(s) of the second reference signal resource to transmit the second signal.

17. The method according to claim 11, wherein a priority of the first signal is higher than a priority of the second signal.

18. A method in a second node for wireless communications, comprising:
transmitting a first signaling and a second signaling;
receiving a first signal in a first symbol group, the first signal being transmitted in PUSCH; and
receiving a second signal in a third symbol group, or dropping receiving a second signal in a third symbol group; a physical-layer channel corresponding to the second signal comprising PUSCH;
wherein the first signaling is used to determine the first symbol group, the second signaling is used to determine a second symbol group, and the second symbol group is assigned to the second signal; the first symbol group is overlapping with the second symbol group; the third symbol group is a subset of the second symbol group, and the third symbol group comprises at least a part of the second symbol group overlapping with the first symbol group; the first signal is associated with a first reference signal resource; the second signal is associated with a second reference signal resource; a transmitter of the first signal transmits the second signal or drops transmitting the second signal in the third symbol group; whether the transmitter of the first node transmits the second signal or drops transmitting the second signal in the third symbol group is related to whether the first reference signal resource and the second reference signal resource belong to a same reference signal resource group in M reference signal resource groups, M being a positive integer greater than 1; when the first reference signal resource and the second reference signal resource belong to a same reference signal resource group in the M reference signal resource groups, the transmitter of the first signal drops transmitting the second signal in the third symbol group; when the first reference signal resource and the second reference signal resource respectively belong to different reference signal resource groups in the M reference signal resource groups, the transmitter of the first signal transmits the second signal in the third symbol group.

19. The method according to claim 18, wherein any reference signal resource in the M reference signal resource groups corresponds to a first-type index, and the M reference signal resource groups correspond one-to-one with M index values; the first-type indices corresponding to all reference signal resources in any of the M reference signal resource groups are equal to a corresponding index value; any two of the M index values are not equal; the first-type index corresponding to a reference signal resource is comprised in configuration information of a reference signal resource set to which the reference signal resource belongs; the reference signal resource set comprises an SRS resource set, and any reference signal resource in the M reference signal resource groups is an SRS resource;
or, M TCI state groups correspond one-to-one with the M reference signal resource groups, and the M TCI state groups respectively comprise a TCI state; the M TCI state groups correspond one-to-one with M CORESET pools; a first reference signal resource group is any of the M reference signal resource groups; a first TCI state group is a TCI state group corresponding to the first reference signal resource group in the M TCI state groups;
for any given reference signal resource in the first reference signal resource group, a TCI state in the first TCI state group is used to determine a spatial relation of the given reference signal resource, or a TCI state in the first TCI state group indicates the given reference signal resource.

20. The method according to claim 18, wherein the first signal and the second signal belong to a same carrier, the M reference signal resource groups correspond one-to-one with M cells, and all reference signal resources in any of the M reference signal resource groups are associated with a corresponding cell.
